(19) United States
(12) Patent Application Publication
(10) Pub. No.: US 2017/0336887 A1
(43) Pub. Date: Nov. 23, 2017

(54) INFORMATION PROCESSING SYSTEM AND INFORMATION PROCESSING METHOD

(71) Applicant: Sony Corporation, Tokyo (JP)

(72) Inventors: Haruo Oba, Kanagawa (JP); Atsushi Koshiyama, Tokyo (JP)

(73) Assignee: Sony Corporation, Tokyo (JP)

(21) Appl. No.: 15/670,462

(22) Filed: Aug. 7, 2017

Related U.S. Application Data
(62) Division of application No. 12/589,873, filed on Oct. 29, 2009.

(30) Foreign Application Priority Data
Nov. 25, 2008 (JP) P2008-299408

(51) Int. Cl. G06F 3/041; G06F 1/16; G06F 3/044; G06F 3/0488

(52) U.S. Cl. CPC G06F 3/041; G06F 3/04883; G06F 3/0488; G06F 1/1626; G06F 3/0416; G06F 3/044

(57) ABSTRACT

An information processing system includes: a sensor unit that detects the three-dimensional position of an object according to variations of electrostatic capacitances; and a control unit that performs display dependent on the detected three-dimensional position at a position on a display unit determined with positions in directions orthogonal to a direction of separation in which the object and the sensor unit are located at a distance from each other.

### CROSS-REFERENCE TO RELATED APPLICATIONS

The present application is a divisional of U.S. application Ser. No. 12/589,873 filed on Oct. 29, 2009, which claims priority from Japanese Patent Application No. JP 2008-299408 filed in the Japanese Patent Office on Nov. 25, 2008, the disclosures of which are hereby incorporated by reference.

### BACKGROUND OF THE INVENTION

### Field of the Invention

The present invention relates to an information processing system and an information processing method that perform predetermined display using the front surface of, for example, a table as a display area.

### Description of the Related Art

An idea that a predetermined display image is displayed using the front surface of, for example, a conference table as a display area is presumably applied to various usages.

For example, in patent document 1 (JP-A-2001-109570), an information input/output system is described that a display image emulating a desktop of a computer is displayed on the front surface of a conference table. According to the patent document 1, an image projected or outputted from a projection apparatus (a projector) is projected on the front surface of the table via a reflecting mirror in order to thus display a display image on the front surface of the table.

In the information input/output system described in the patent document 1, a three-dimensional position sensor is attached to computer equipment such as a personal digital assistant (PDA), and display control concerning a display image can be implemented based on an action a user performs with the PDA. For example, a document displayed on a display screen is moved or rotated on the display screen according to an action a conferee performs using the PDA.

### SUMMARY OF THE INVENTION

According to the patent document 1, a display image displayed on the front surface of the table is projected or displayed as a predetermined one irrespective of the positions of conferees seated at the table. Therefore, for example, when a document that is a conference material is displayed, if the any of the conferees wants to read the document, the conferee has to move to the position at which the document is displayed.

The present invention addresses the foregoing situation. It is desirable to provide an information processing system capable of autonomously performing predetermined image display in a place where a user lies.

According to an embodiment of the present invention, there is provided an information processing system including:

a sensor unit that detects the three-dimensional position of an object according to variations of electrostatic capacitances; and

a control unit that performs display dependent on the detected three-dimensional position at a position on a display unit, which is determined with positions in directions orthogonal to a direction of separation in which the object and the sensor unit are located at a distance from each other.

In the embodiment of the present invention having the foregoing components, if the object is, for example, a person, processing actions to be described below are performed.

The sensor unit recognizes a person as the object and detect electrostatic capacitances that vary depending on the three-dimensional position of the person. The three-dimensional position of the person who is the object is detected based on a sensor output of the sensor unit.

The control units reference the positions in the directions, which are orthogonal to the direction of separation in which the person and the sensor unit are located at a distance from each other, that is, a z direction, that is, x and y directions which are components of the three-dimensional position of the person detected by the sensor unit. The control unit performs display at a display position on the display unit, which is determined with the positions in the x and y directions, according to the position of the person.

Therefore, for example, when a person is seated at the table, predetermined display such as display of a document can be performed in a display area in the vicinity of the person who is seated.

According to the embodiment of the present invention, since predetermined display can be performed at a position on a display unit determined with the three-dimensional position of an object, the predetermined display can be performed at the position associated with the position of the object.

### BRIEF DESCRIPTION OF THE DRAWINGS

FIG. 1 is an exploded perspective diagram showing an example of components of a table employed in an information processing system in accordance with a first embodiment of the present invention;

FIG. 2 is a diagram for use in explaining a control function of the information processing system in accordance with the first embodiment of the present invention;

FIG. 3 is a diagram for use in explaining an example of the structure of the table employed in the information processing system in accordance with the first embodiment of the present invention;

FIGS. 4A and 4B are diagrams for use in explaining examples of the structure of a sensor unit employed in the information processing system in accordance with the first embodiment of the present invention;

FIG. 5 is a diagram for use in explaining an example of the structure of the sensor unit employed in the information processing system in accordance with the first embodiment of the present invention;

FIG. 6 is a block diagram for use in explaining an example of the hardware configuration of the information processing system in accordance with the first embodiment of the present invention;

FIG. 7 is a block diagram for use in explaining an example of the hardware configuration of the information processing system in accordance with the first embodiment of the present invention;

FIG. 8 is a diagram for use in explaining an example of processing actions to be performed in the information processing system in accordance with the first embodiment of the present invention;

FIG. 9 is a diagram for use in explaining the example of processing actions to be performed in the information processing system in accordance with the first embodiment of the present invention;

FIG. 10 is a diagram for use in explaining the example of processing actions to be performed in the information processing system in accordance with the first embodiment of the present invention;

FIGS. 11A and 11B are diagrams for use in explaining an example of assignments of layers, which depend on a distance from a sensor unit to an object, in the information processing system in accordance with the first embodiment of the present invention;

FIG. 12 is a diagram showing a flowchart describing an example of processing actions to be performed in the information processing system in accordance with the first embodiment of the present invention;

FIG. 13 is a diagram showing a flowchart describing an example of processing actions to be performed in the information processing system in accordance with the first embodiment of the present invention;

FIG. 14 is a diagram showing part of a flowchart describing an example of processing actions to be performed in the information processing system in accordance with the first embodiment of the present invention;

FIGS. 15A and 15B are diagrams for use in explaining processing actions to be performed in the information processing system in accordance with the first embodiment of the present invention;

FIG. 16 is a diagram for use in explaining an information processing system in accordance with a second embodiment of the present invention;

FIG. 17 is a diagram for use in explaining the information processing system in accordance with the second embodiment of the present invention;

FIG. 18 is a diagram for use in explaining the information processing system in accordance with the second embodiment of the present invention;

FIG. 19 is a diagram for use in explaining the information processing system in accordance with the second embodiment of the present invention;

FIG. 20 is a diagram for use in explaining the information processing system in accordance with the second embodiment of the present invention;

FIG. 21 is a diagram showing a flowchart describing an example of processing actions to be performed in the information processing system in accordance with the second embodiment of the present invention;

FIG. 22 is a diagram showing a flowchart describing an example of processing actions to be performed in the information processing system in accordance with the second embodiment of the present invention;

FIG. 23 is a diagram for use in explaining an example of components of an information processing system in accordance with a third embodiment of the present invention; and

FIG. 24 is a block diagram for use in explaining an example of the hardware configuration of the information processing system in accordance with the third embodiment of the present invention.

### DESCRIPTION OF THE PREFERRED EMBODIMENTS

Referring to the drawings, information processing systems in accordance with embodiments of the present invention will be described below.

### First Embodiment

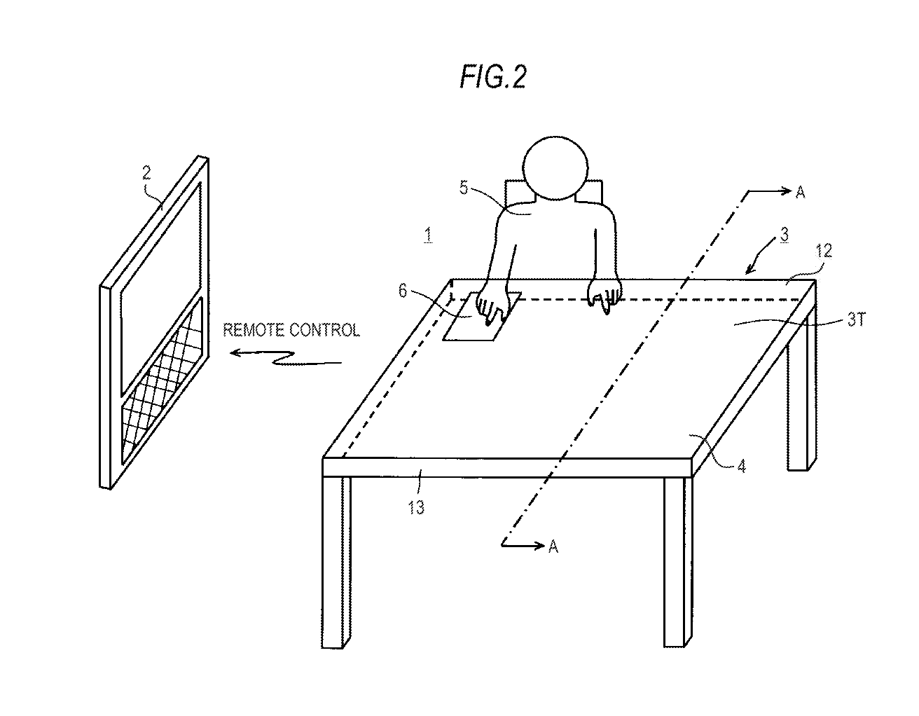

FIG. 2 is a diagram for use in explaining the outline of an information processing system in accordance with a first embodiment. The information processing system 1 of the first embodiment has the capability of a remote commander (remote-control transmitter) for, for example, a television set 2.

The information processing system 1 of the first embodiment is constructed as a system incorporated in a table 3. The table 3 in the present embodiment is made of a nonconductor, for example, a woody material.

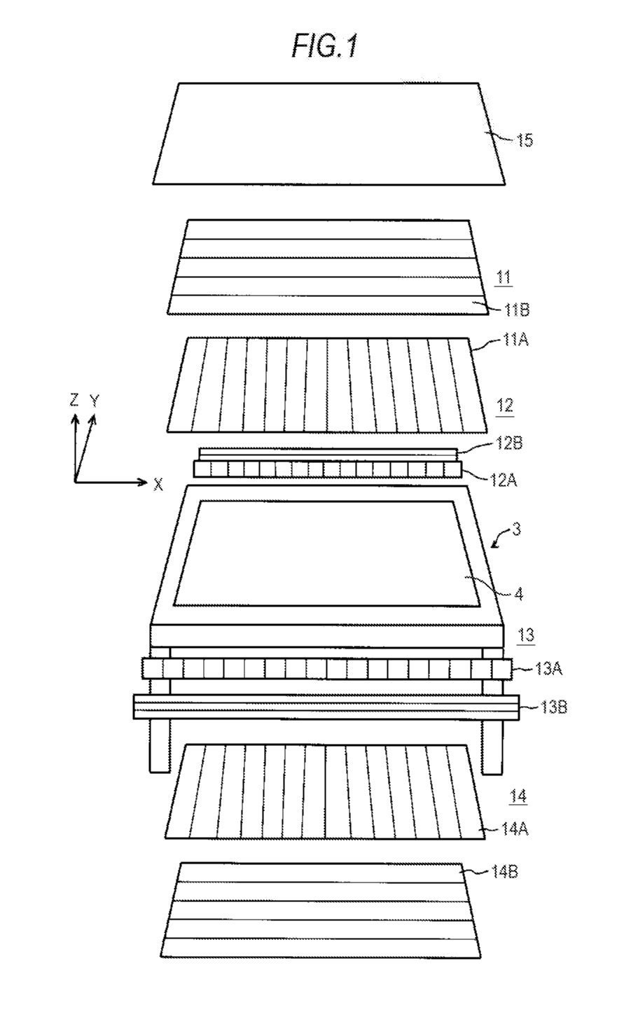

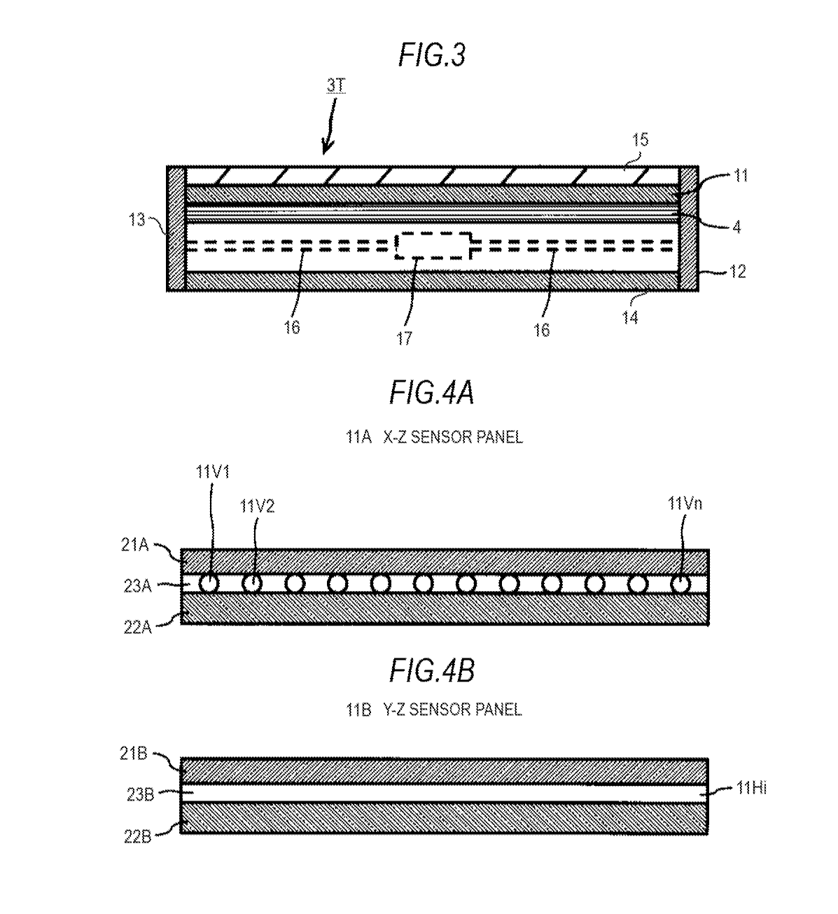

FIG. 1 is an exploded diagram for use in explaining the major components of the table 3 in which the information processing system 1 of the present embodiment is incorporated. FIG. 3 is a sectional view (showing a plane along an A-A cutting line in FIG. 2) of a tabletop 3T of the table 3 formed with a flat plate.

In the information processing system 1 of the present embodiment, a display panel 4 is disposed on the side of the front surface of the tabletop 3T of the table 3, and a sensor unit (not shown in FIG. 2) capable of sensing a person as an object is included. In the present embodiment, as the sensor unit, a sensor unit which uses an electrostatic capacitance to detect the three-dimensional position of the object relative to the sensor unit and which are disclosed in patent document 2 (JP-A-2008-117371) the present applicant has disclosed previously are adopted.

The display panel 4 is realized with a flat display panel 4, for example, a liquid crystal display panel or an organic electroluminescent display panel.

The sensor unit includes, in the present embodiment, a front sensor unit 11, lateral sensor units 12 and 13, and a rear sensor unit 14. The front sensor unit 11, lateral sensor units 12 and 13, and rear sensor unit 14 are independent of one another.

The front sensor unit 11 is layered on the upper side of the flat display panel 4.

The lateral sensor units 12 and 13 are disposed on two side surfaces of the table 3 in the direction of the long sides thereof. In this example, the lateral sensor units 12 and 13 alone are disposed on the side surfaces of the table 3 on the assumption that a user is seated only in the direction of the long sides of the table 3. However, if a consideration is taken into a case where the user may be seated in the direction of the short sides of the table 3, lateral sensor units may be disposed on two side surfaces of the table 3 in the direction of the short sides thereof.

The rear sensor unit 14 is disposed on the side of the rear surface of the tabletop of the table 3.

The front surface of the front sensor unit 11 is protected with a table front cover 15. The table front cover 15 is formed with a transparent member so that a user can view a display image displayed on the display panel 4 from above. In the present embodiment, since the sensor units detect a spatial position of an object using an electrostatic capacitance, the table front cover is made of a non-conducting material. At least the front sensor unit 11 is, as described later, formed using a transparent glass substrate so that a user can view a display image displayed on the display panel 4 from above.

In the present embodiment, a printed wiring substrate 16 on which a control unit 17 is formed is disposed inside the tabletop 3T of the table 3.

The flat display panel 4 is connected to the control unit 17 via the printed wiring substrate 16. In addition, the front sensor unit 11, lateral sensor units 12 and 13, and rear sensor unit 14 are connected to the control unit 17. In the present embodiment, the control unit 17 receives sensor outputs from the sensors 11, 12, 13, and 14, displays a display image on the display panel 4 according to the received sensor outputs, and controls the display image.

Each of the front sensor unit 11, lateral sensor units 12 and 13, and rear sensor unit 14 provides sensor detection outputs dependent on a spatial distance of separation by which a human body or a human hand that is an object is separated from each sensor unit. In the present embodiment, each of the front sensor unit 11, lateral sensor units 12 and 13, and rear sensor unit 14 is formed by bonding two rectangular sensor panels having a predetermined size and a two-dimensional flat surface.

The two sensor panels to be bonded are, as shown in FIG. 1, an X-Z sensor panel and a Y-Z sensor panel. Specifically, the front sensor unit 11 has an X-Z sensor panel 11A and a Y-Z sensor panel 11B bonded. The lateral sensor unit 12 has an X-Z sensor panel 12A and a Y-Z sensor panel 12B bonded. The lateral sensor unit 13 has an X-Z sensor panel 13A and a Y-Z sensor panel 13B bonded. The rear sensor unit 14 has an X-Z sensor panel 14A and a Y-Z sensor panel 14B bonded.

In the present embodiment, since the sensor units 11, 12, 13, and 14 are structured as mentioned above, they can provide sensor detection outputs, which depend on distances to an object, independently of one another at multiple positions in the sideway and lengthwise directions of the sensor panel surfaces. Therefore, in the present embodiment, the sensor units 11, 12, 13 and 14 can detect on which of the sensor panel surfaces the object is located.

Specifically, assuming that, for example, the sideways direction of each sensor panel surface is defined as an x-axis direction, the lengthwise direction thereof is defined as a y-axis direction, and a direction orthogonal to the sensor panel surface is defined as a z-axis direction, the spatial distance of separation of an object is detected as a z-axis value or a z-coordinate. The spatial position of the object above each of the sensor panels is detected with an x-axis value and a y-axis value, or an x-coordinate and a y-coordinate.

Therefore, the sensor detection output of each of the sensor units 11, 12, 13, and 14 depends on a position (x-coordinate, y-coordinate) on a sensor panel surface of an object, and a spatial distance of separation (z-coordinate) thereof.

### (Example of the Detailed Structure of a Sensor Unit)

Next, an example of the structures of the X-Z sensor panel and Y-Z sensor panel will be described below. Since the structures of the X-Z sensor panel and Y-Z sensor panel are identical among the sensor units 11, 12, 13, and 14, a description will be made by taking for instance the X-Z sensor panel 11A and Y-Z sensor panel 11B of the surface sensor unit 11.

The X-Z sensor panel 11A and Y-Z sensor panel 11B each have, in this example, multiple wire electrodes arranged in two mutually orthogonal directions.

In the X-Z sensor panel 11A, multiple lengthwise electrodes 11V1, 11V2, 11V3, etc., and 11Vn (where n denotes an integer equal to or larger than 2) whose extending direction of the wire electrode is a vertical direction (lengthwise direction) in FIG. 1 are disposed equidistantly in a horizontal direction (sideways direction) in FIG. 1.

In the Y-Z sensor panel 11B, multiple sideways electrodes 11H1, 11H2, 11H3, etc., and 11Hm (where m denotes an integer equal to or larger than 2) whose extending direction of the wire electrode is the horizontal direction (sideways direction) in FIG. 1 are disposed equidistantly in the vertical direction (lengthwise direction) in FIG. 1.

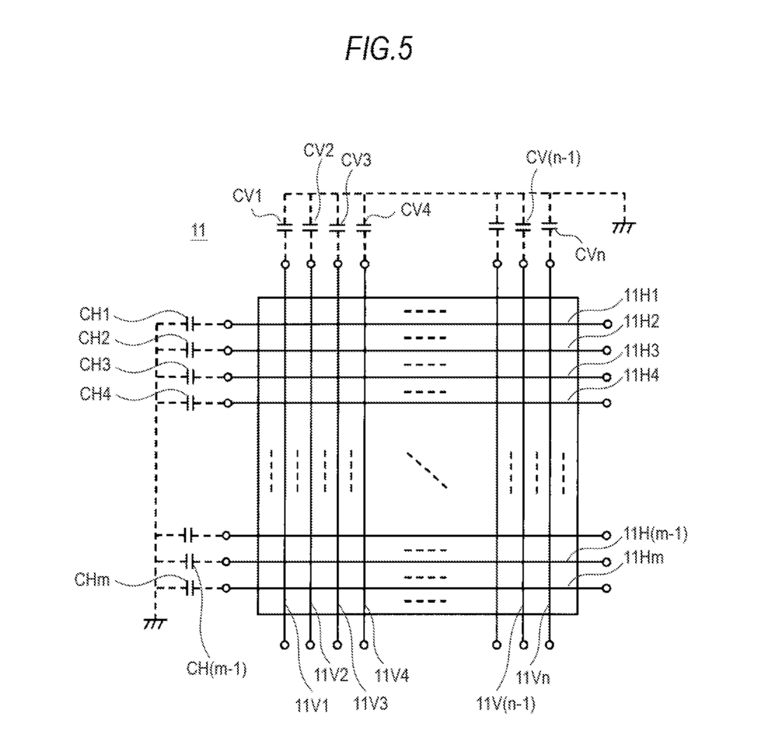

FIGS. 4A and 4B are lateral sectional views showing the X-Z sensor panel 11A and Y-Z sensor panel 11B respectively.

The X-Z sensor panel 11A has an electrode layer 23A, which contains the multiple lengthwise electrodes 11V1, 11V2, 11V3, etc., and 11Vn, sandwiched between two glass plates 21A and 22A.

The Y-Z sensor panel 11B has an electrode layer 23B, which contains the multiple sideways electrodes 11H1, 11H2, 11H3, etc., and 11Hm, sandwiched between two glass plates 21B and 22B. Reference numeral 11Hi in FIG. 4B denotes the i-th sideways electrode.

In the present embodiment, the multiple sideways electrodes 11H1, 11H2, 11H3, etc., and 11Hm and the multiple lengthwise electrodes 11V1, 11V2, 11V3, etc., and 11Vn are constructed by printing or depositing a conducting ink onto the glass plates. Preferably, the multiple sideways electrodes 11H1, 11H2, 11H3, etc., and 11Hm and the multiple lengthwise electrodes 11V1, 11V2, 11V3, etc., and 11Vn are formed with transparent electrodes.

Next, a description will be made of the circuitry that obtains a sensor output, which depends on the three-dimensional position of an object, from the sensor panel having the X-Z sensor panel 11A and Y-Z sensor panel 11B layered.

Even in the present embodiment, similarly to the case described in the patent document 2, an electrostatic capacitance dependent on a distance between the X-Z sensor panel 11A and Y-Z sensor panel 11B of the front sensor unit 11 and an object is converted into an oscillatory frequency of an oscillatory circuit and thus detected. In the present embodiment, the front sensor unit 11 counts the number of pulses of a pulsating signal whose frequency corresponds to the oscillatory frequency, and provides the count value associated with the oscillatory frequency as a sensor output signal.

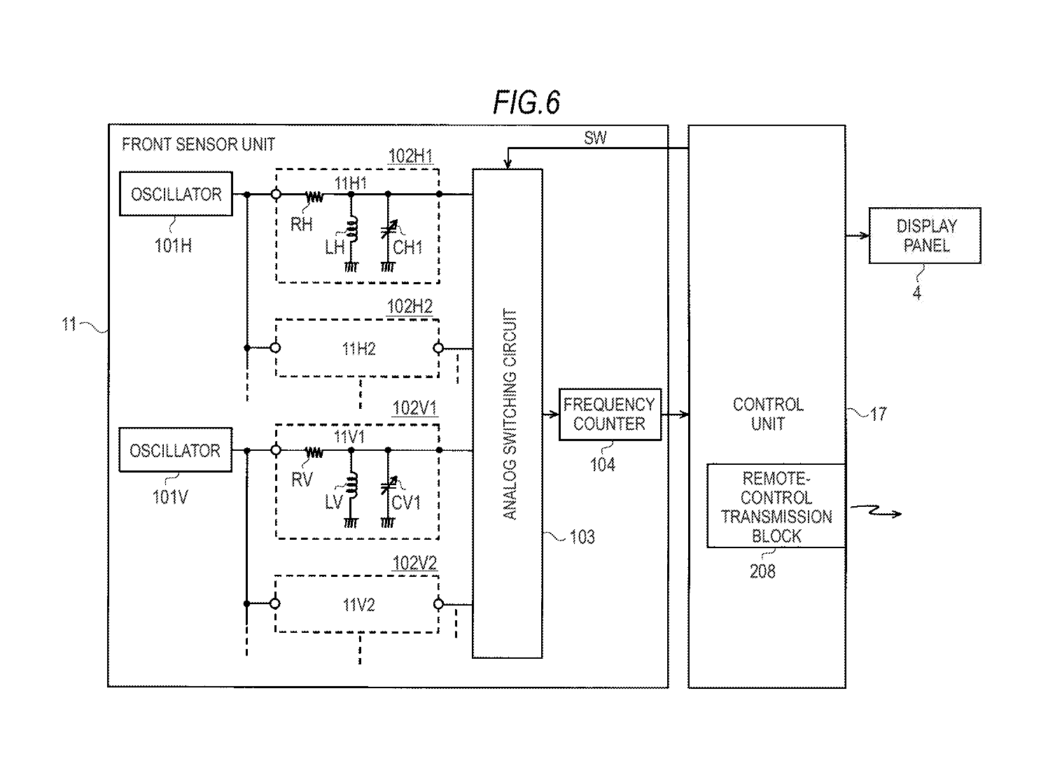

FIG. 5 is an explanatory diagram showing a sensor panel formed by layering the X-Z sensor panel 11A and Y-Z sensor panel 11B. FIG. 6 shows an example of the circuitry that produces a sensor detection output signal to be outputted from the front sensor unit 11.

As shown in FIG. 5, in the X-Z sensor panel 11A and Y-Z sensor panel 11B of the front sensor unit 11 included in the present embodiment, the multiple wire electrodes are, as mentioned above, arranged in the two mutually orthogonal directions. Specifically, the multiple lengthwise electrodes 11V1, 11V2, 11V3, etc., and 11Vn, and the multiple sideways electrodes 11H1, 11H2, 11H3, etc., and 11Hm are arranged in the mutually orthogonal directions.

In this case, electrostatic capacitors (stray capacitors) CH1, CH2, CH3, etc., and CHm exist between the multiple sideways electrodes 11H1, 11H2, 11H3, etc., and 11Hm and a ground. The electrostatic capacitances CH1, CH2, CH3, etc., and CHm vary depending on the location of a hand or fingers in a space above the Y-Z sensor panel 11B.

One ends of the multiple sideways electrodes 11H1, 11H2, 11H3, etc., and 11Hm and the other ends thereof are formed as sideways electrode terminals. In this example, the sideways electrode terminals at one ends of the sideways electrodes 11H1, 11H2, 11H3, etc., and 11Hm are connected to an oscillator 101H for sideways electrodes shown in FIG. 6.

The sideways electrode terminals at the other ends of the multiple sideways electrodes 11H1, 11H2, 11H3, etc., and 11Hm are connected to an analog switching circuit 103.

In this case, the sideways electrodes 11H1, 11H2, 11H3, etc., and 11Hm are expressed with equivalent circuits like the one shown in FIG. 6. In FIG. 6, an equivalent circuit of the sideways electrode 11H1 is shown. The same applies to the equivalent circuits of the other sideways electrodes 11H2, etc., and 11Hm.

Specifically, the equivalent circuit of the sideways electrode 11H1 includes a resistor RH, an inductor LH, and an electrostatic capacitor CH1 whose capacitance is an object of detection. For the other sideways electrodes 11H2, 11H3, etc., and 11Hm, the electrostatic capacitor is changed to the electrostatic capacitor CH2, CH3, etc., or CHm.

The equivalent circuits of the sideways electrodes 11H1, 11H2, 11H3, etc., and 11Hm serve as resonant circuits. Each of the resonant circuits and the oscillator 101H constitute an oscillatory circuit. The oscillatory circuits serve as sideways electrode capacitance detection circuits 102H1, 102H2, 102H3, etc., and 102Hm respectively. The outputs of the sideways electrode capacitance detection circuits 102H1, 102H2, 102H3, etc., and 102Hm are signals whose oscillatory frequencies are associated with the electrostatic capacitances CH1, CH2, CH3, etc., and CHm dependent on the distance of an object from the sensor panel surface of the front sensor unit 11.

If a user approaches or recedes his/her hand or fingertip to or from the Y-Z sensor panel 11B above the Y-Z sensor panel 11B, the electrostatic capacitances CH1, CH2, CH3, etc., and CHm vary. Therefore, the sideways electrode capacitance detection circuits 102H1, 102H2, 102H3, etc., and 102Hm each detect the change in the position of the hand or fingertip as a variation in the oscillatory frequency of the oscillatory circuit.

One ends of the multiple lengthwise electrodes 11V1, 11V2, 11V3, etc., and 11Vn and the other ends thereof are formed as lengthwise electrode terminals. In this example, the lengthwise electrode terminals of the multiple lengthwise electrodes 11V1, 11V2, 11V3, etc., and 11Vn at one ends thereof are connected to an oscillator 101V for lengthwise electrodes. In this example, the basic frequency of an output signal of the oscillator 101V for lengthwise electrodes is different from that of the oscillator 101H for lengthwise electrodes.

The lengthwise electrode terminals of the multiple lengthwise electrodes 11V1, 11V2, 11V3, etc., and 11Vn at the other ends thereof are connected to the analog switching circuit 103.

In this case, the lengthwise electrodes 11V1, 11V2, 11V3, etc., and 11Vn are, similarly to the sideways electrodes, expressed with equivalent circuits like the one shown in FIG. 6. In FIG. 6, the equivalent circuit of the lengthwise electrode 11V1 is shown. The same applies to the equivalent circuits of the other lengthwise electrodes 11V2, etc., and 11Vn.

Specifically, the equivalent circuit of the lengthwise electrode 11V1 includes a resistor RV, an inductor LV, and an electrostatic capacitor CV1 whose capacitance is an object of detection. For the other lengthwise electrodes 11V2, 11V3, etc., and 11Vn, the electrostatic capacitance is changed to the electrostatic capacitance CV2, CV3, etc., or CVn.

The equivalent circuits of the lengthwise electrodes 11V1, 11V2, 11V3, etc., and 11Vn serve as resonant circuits. Each of the resonant circuits and the oscillator 101V constitute an oscillatory circuit. The oscillatory circuits serve as lengthwise electrode capacitance detection circuits 102V1, 102V2, 102V3, etc., and 102Vn respectively. The outputs of the lengthwise electrode capacitance detection circuits 102V1, 102V2, 102V3, etc., and 102Vn are signals whose oscillatory frequencies are associated with electrostatic capacitances CV1, CV2, CV3, etc., and Cvn dependent on the distance of an object from the X-Z sensor panel 11A.

Each of the lengthwise electrode capacitance detection circuits 102V1, 102V2, 102V3, etc., and 102Vn detects a variation in the electrostatic capacitance CV1, CV2, CV3, etc., or CVn, which depends on a change in the position of the hand or fingertip, as a variation in the oscillatory frequency of the oscillatory circuit.

The outputs of the sideways electrode capacitance detection circuits 102H1, 102H2, 102H3, etc., and 102Hm, and the outputs of the lengthwise electrode capacitance detection circuits 102V1, 102V2, 102V3, etc., and 102Vn are fed to the analog switching circuit 103.

The analog switching circuit 103 selects and outputs at a predetermined speed one of the outputs of the sideways electrode capacitance detection circuits 102H1 to 102Hm and the outputs of the lengthwise electrode capacitance detection circuits 102V1 to 102Vn in response to a switching signal SW sent from the control unit 17.

An output sent from the analog switching circuit 103 is fed to a frequency counter 104. The frequency counter 104 counts the oscillatory frequency represented by an input signal. Specifically, since the input signal of the frequency counter 104 is a pulsating signal whose frequency corresponds to the oscillatory frequency, when the number of pulses of the pulsating signal generated during a predetermined time interval is counted, the count value corresponds to the oscillatory frequency.

The output count value of the frequency counter 104 is fed as a sensor output, which is produced by the wire electrode selected by the analog switching circuit 103, to the control unit 17. The output count value of the frequency counter 104 is obtained synchronously with the switching signal SW fed from the control unit 17 to the analog switching circuit 103.

Therefore, the control unit 17 decides based on the switching signal SW, which is fed to the analog switching circuit 103, to which of the wire electrodes the output count value of the frequency counter 104 serving as a sensor output relates. The control unit 17 then preserves the output count value in association with the wire electrode in a buffer included therein.

The control unit 17 detects the spatial position of an object (a distance from the front sensor unit 11 and (x-coordinate, y-coordinate) in the front sensor unit 11) on the basis of the sensor outputs which are produced by all the wire electrodes in relation to objects of detection and which are preserved in the buffer.

In reality, according to the position (x-coordinate, y-coordinate) of an object above the sensor panel of the front sensor unit 11, sensor outputs are obtained from the multiple sideways electrode capacitance detection circuits 102H1 to 102Hm and the multiple lengthwise electrode capacitance detection circuits 102V1 to 102Vn which are included in the front sensor unit 11. The distance from the position (x-coordinate, y-coordinate) of the object above the sensor panel of the front sensor unit 11 to the sensor unit 10 is the shortest. Therefore, the sensor outputs sent from the sideways electrode capacitance detection circuit and lengthwise electrode capacitance detection circuit which detect electrostatic capacitances connected to two electrodes associated with the x-coordinate and y-coordinate respectively are distinguished from the other sensor outputs.

As mentioned above, the control unit 17 obtains the x-coordinate and y-coordinate, which determine the position of an object above the front sensor unit 11, and the distance from the front sensor unit 11 to the object on the basis of the multiple sensor outputs of the front sensor unit 11. Specifically, the position of the object, for example, the hand is recognized as existing in the space defined with the detected x-coordinate and y-coordinate. Since the object has a predetermined size, the object is detected to be separated from the sensor panel of the front sensor unit 11 by a distance, which depends on electrostatic capacitances, within a range that is equivalent to the size of the object and that includes the position determined with the x-coordinate and y-coordinate.

Even in the present embodiment, similarly to the case described in the patent document 2, the wire electrodes that detect electrostatic capacitances are thinned or switched according to the distance of separation of the spatial position of an object from the sensor panel surface of the front sensor unit 11. For the thinning or switching of the wire electrodes, the analog switching circuit 103 controls in response to a switching control signal SW, which is sent from the control unit 17, how many wire electrodes (including zero wire electrode) are skipped to select the next wire electrode. The switching timing is predetermined based on the distance from the sensor panel surface of the front sensor unit 11 to the object, for example, based on a point at which layers to be described later are changed.

In the above description, the oscillators for sideways electrodes and lengthwise electrodes are employed. Concisely, one common oscillator may be employed. Ideally, multiple oscillators that provide outputs at different frequencies are included in association with the wire electrodes.

As mentioned above, the front sensor unit 11 provides sensor outputs that depend on the three-dimensional position of an object located at a spatially separated position in a space above the sensor panel surface of the front sensor unit 11.

The above description is concerned with the front sensor unit 11. As mentioned previously, the same applies to the lateral sensor units 12 and 13 and rear sensor unit 14.

In the information processing system 1 of the present embodiment, the control unit 17 implements display control and remote control, which are described below, on the basis of the sensor outputs of the sensor units 11 to 14.

In the information processing system 1 of the first embodiment, when a user 5 is seated at any position in the direction of the long sides of the table 3, the sensor units 11 to 14 provide the control unit 17 with sensor outputs which depend on the user's position of seating (three-dimensional position).

In this case, the lateral sensor unit 12 or 13 provides the control unit 17 with sensor outputs that depend on the position (x-coordinate, y-coordinate) of the abdomen of the seated user in the direction of the long sides of the table 3 and a seated-user approachable distance (z-coordinate) to the sensor panel surface of the lateral sensor unit 12 or 13. The rear sensor unit 14 provides the control unit 17 with sensor outputs dependent on both the position (x-coordinate, y-coordinate) of the seated user's thigh below the rear surface of the table 3, and an approachable distance (z-coordinate) of the seated user's thigh to the sensor panel surface of the rear sensor unit 14.

When the seated user raises his/her hand above the table 3, the front sensor unit 11 provides the control unit 17 with sensor outputs according to both the position (x-coordinate, y-coordinate) of the hand above the sensor panel surface of the front sensor unit 11 and the approachable distance (z-coordinate) of the user's hand relative to the sensor panel.

The control unit 17 detects the position of seating of the user 5 at the table 3 on the basis of the sensor outputs sent from the sensor units 11 to 14, and displays a remote-control commander image 6 at a position near the position of seating on the display screen of the display panel 4. In other words, in the information processing system 1 of the first embodiment, the remote-control commander image 6 is automatically displayed at a position, which depends on the position of seating of the user 5, on the display panel 4.

In the information processing system 1 of the first embodiment, the gesture the user 5 makes in the space above the remote commander image 6 is transmitted to the control unit 17 via the front sensor unit 11. The control unit 17 discriminates the contents of the gesture, and produces a remote-control signal, with which predetermined remote control is implemented, according to the result of the discrimination.

For example, the user 5 may vary the distance of his/her hand to the surface of the table 3 (a motion in the z-axis direction) in the space above the remote commander image 6, or may move his/her hand in a direction parallel to the surface of the table 3 (a motion in the x-axis or y-axis direction).

The front sensor unit 11 feeds sensor outputs, which depend on the three-dimensional position of the hand, to the control unit 17. The control unit 17 detects the hand gesture on the basis of the sensor outputs received from the front sensor unit 11. The control unit 17 then produces a remote-control signal, with which a volume of, for example, the television set 2 is controlled or change of channels is controlled, according to the detected hand gesture the user 5 has made in the space above the remote commander image.

The control unit 17 feeds the produced remote-control signal to the television set 2. Thus, remote control of the television set 2 by the information processing system 1 of the present embodiment is enabled.

### (Example of the Configuration of the Control Unit 17)

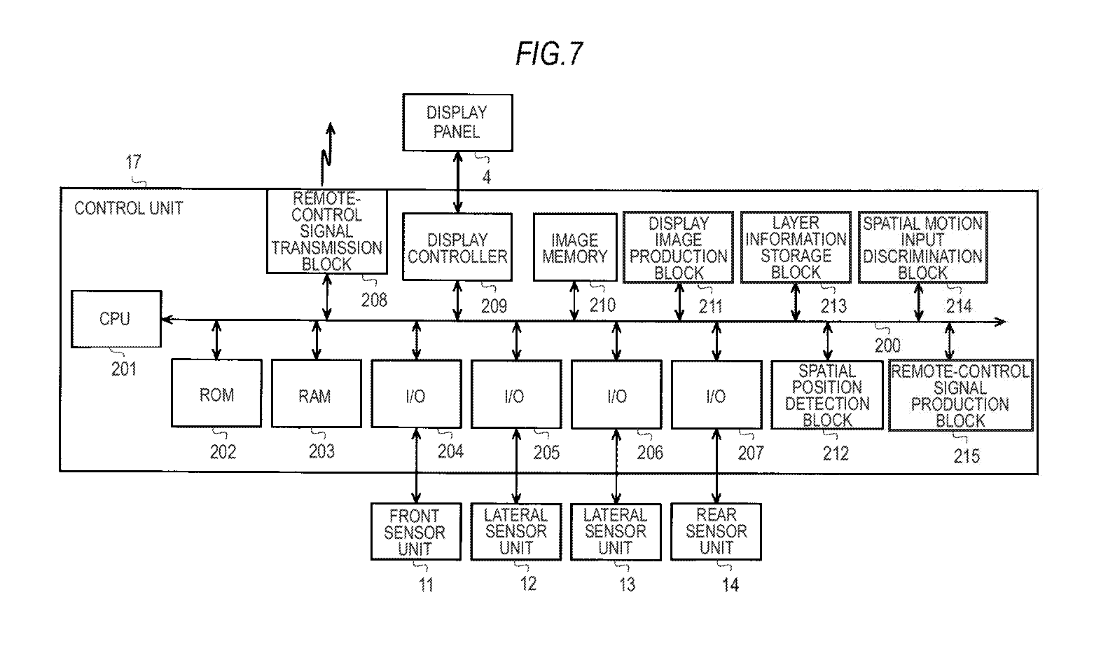

The control unit 17 includes a microcomputer. Specifically, as shown in FIG. 7, the control unit 17 has a program read-only memory (ROM) 202 and a work area random access memory (RAM) 203 connected to a central processing unit (CPU) 201 over a system bus 200.

In the present embodiment, input/output ports 204 to 207, a remote-control transmission block 208, a display controller 209, an image memory 210, and a display image information production block 211 are connected onto the system bus 200. In addition, a spatial position detection block 212, a layer information storage block 213, a spatial motion input discrimination block 214, and a remote-control signal production block 215 are connected onto the system bus 200.

The display image production block 211, spatial position detection block 212, and spatial motion input discrimination block 214 are functional blocks that may be implemented as pieces of software processing which the CPU 201 executes according to programs stored in the ROM 202.

The input/output ports 204, 205, 206, and 207 are connected to the front sensor unit 11, lateral sensor unit 12, lateral sensor unit 13, and rear sensor unit 14 respectively. Sensor output signals sent from the associated one of the sensor units are received through each of the input/output ports.

The remote-control signal transmission block 208 uses, for example, infrared light to transmit a remote-control signal, which is produced by the remote-control signal production block 215, to a controlled apparatus, that is, in this example, the television set 2.

The display controller 209 is connected to the display panel 4. Display information sent from the control unit 17 is fed to the display panel 4.

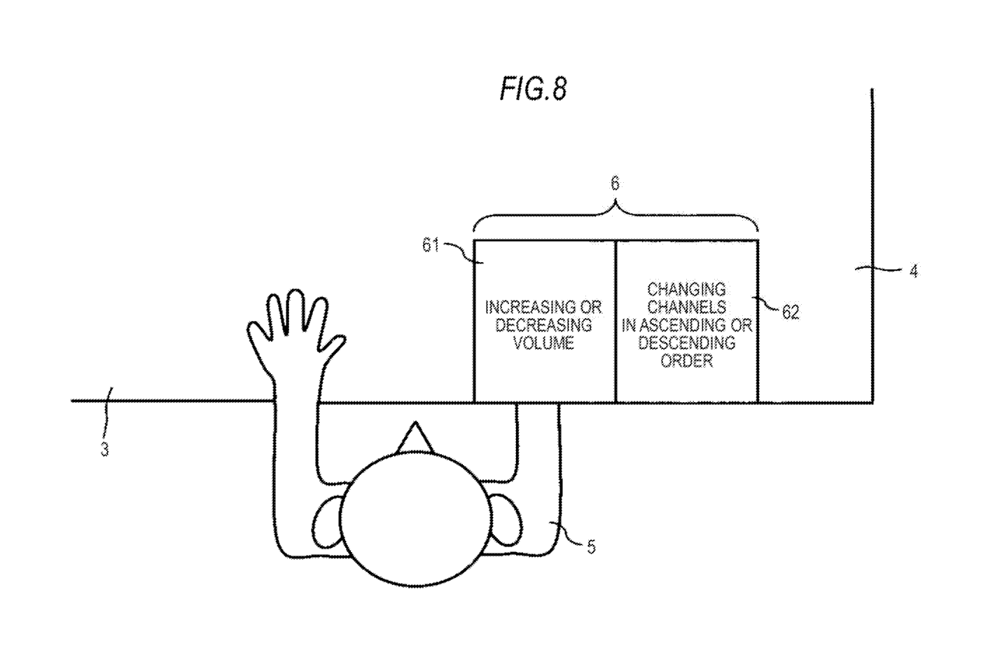

In this example, display-image information concerning the remote commander image 6 is stored in the image memory 210. In this example, for brevity's sake, a remote-control facility to be invoked via the remote commander image 6 is a facility that controls the volume of the television set 2 or a facility that controls sequential change of channels. As the remote commander image 6, as shown in FIG. 8, a volume control display image 61 and a channel sequential change display image 62 are prepared in the image memory 210.

The display image production block 211 reads display-image information concerning the remote commander image 6, which is stored in the image memory 210, under the control of the CPU 201, and produces a display image signal with which the remote commander image 6 is displayed at a position on the display panel 4 according to an instruction issued from the control unit 17.

In the present embodiment, the display image production block 211 displays, as shown in FIG. 8, the volume control display image 61 and channel sequential change display image 62 in adjoining areas on the display panel 4.

In the present embodiment, when a user makes a predetermined gesture in the space above the volume control display image 61 or channel sequential change display image 62 as a spatial motion for controlling the volume or channels, the control unit 17 discriminates the gesture and produces a remote-control signal.

In this case, the volume control display image 61 and channel sequential change display image 62 have the contents thereof modified so as to assist the user's gesture in the space.

In the image memory 210, display images that are modified images of the volume control display image 61 and channel sequential change display image 62 are stored. The display image production unit 211 produces display-image information, based on which the display image of the volume control display image 61 or channel sequential change display image 62 can be modified, under the control of the CPU 201.

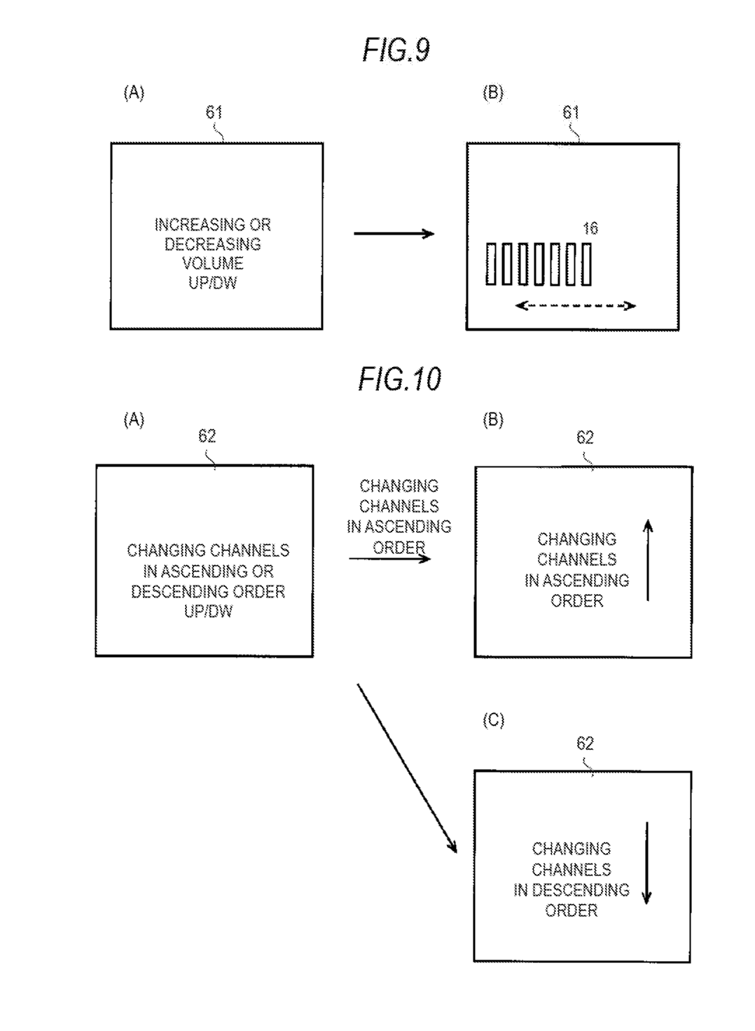

For example, as an initial screen image to be displayed when a user is seated, the contents of the volume control display image 61 signify, as shown in part (A) of FIG. 9, that the volume of the television set is controllable. When a user raises his/her hand to the space above the volume control display image 61, the volume control display image 61 is, as shown in part (B) of FIG. 9, modified to an image in which a sideways bar is stretched or contracted along with a change in the volume and a numerical volume value attained at that time is indicated.

As an initial screen image to be displayed when a user is seated, the channel sequential change display image 62 is, as shown in part (A) of FIG. 10, an image signifying that the channels can be sequentially changed. When a user raises his/her hand to the space above the channel sequential change display image 62, and makes a spatial motion of changing the channels in ascending order as described later, the channel sequential change display image 62 is, as shown in part (B) of FIG. 10, modified into an image signifying that the channels are changed in ascending order. Likewise, when a spatial motion of changing the channels in descending order is made, the channel sequential change display image 62 is, as shown in part (C) of FIG. 10, modified into an image signifying that the channels are changed in descending order.

The spatial position detection block 212 receives the sensor outputs from each of the sensor units 11 to 14, detects the three-dimensional position of an object in the space above each of the sensor panels of the sensor units 11 to 14, and temporarily preserves the information on the three-dimensional position of the object. The spatial position detection block 212 detects, as mentioned previously, the position of seating of a user on the basis of the sensor outputs of the sensor units 11 to 14, and hands the result of the detection to the display image production block 211.

The spatial position detection block 212 detects the three-dimensional position of the seated user's hand in the information space of the front sensor unit 11 on the basis of the sensor outputs sent from the front sensor unit 11, and hands the information on the three-dimensional position, which is the result of the detection, to the spatial motion input discrimination block 214.

Based on the result of the user's position of seating, the display image production block 211 determines an area in the display panel 4 in which the remote commander image 6 is displayed, and displays the remote commander image 6 in the determined area. The display image production block 211 transfers the information on the display area for the remote commander image 6 to the spatial motion input discrimination block 214.

In the present embodiment, information on layers defined based on distances from the sensor panel surface of the front sensor unit 11 in the space above the surface of the table 3, which is sensed by the front sensor unit 11, is stored in the layer information storage block 213. In this example, information necessary to produce a remote-control signal with which the volume is controlled or the channels are sequentially changed is stored as the information on layers. The information on layers to be stored in the layer information storage block 213 will be detailed later.

The spatial motion input discrimination block 214 discriminates a user's remote-control spatial motion input on the basis of both the information on the display area for the remote commander image 6 sent from the display image production block 211 and the three-dimensional position of the seated user's hand in the information space for the front sensor unit 11 sent from the spatial position detection block 212.

Specifically, the spatial motion input discrimination block 214 receives the information on the three-dimensional position of the user's hand, and discriminates on which of multiple defined layers the user's hand is located or the hand gesture.

The spatial motion input discrimination block 214 references the contents of storage in the layer information storage block 213, identifies remote control assigned to the discriminated user's hand gesture, and transfers the result of the identification to the remote-control signal production block 215.

The remote-control signal production block 215 produces a remote-control signal associated with the result of the identification of remote control sent from the spatial motion input discrimination block 214, and hands the remote-control signal to the remote-control signal transmission block 208. The remote-control signal transmission block 208 receives the remote-control signal, and executes transmission of the remote-control signal using infrared light.

### (Display Area for the Remote Commander Image, and Multiple Layers in the Information Space)

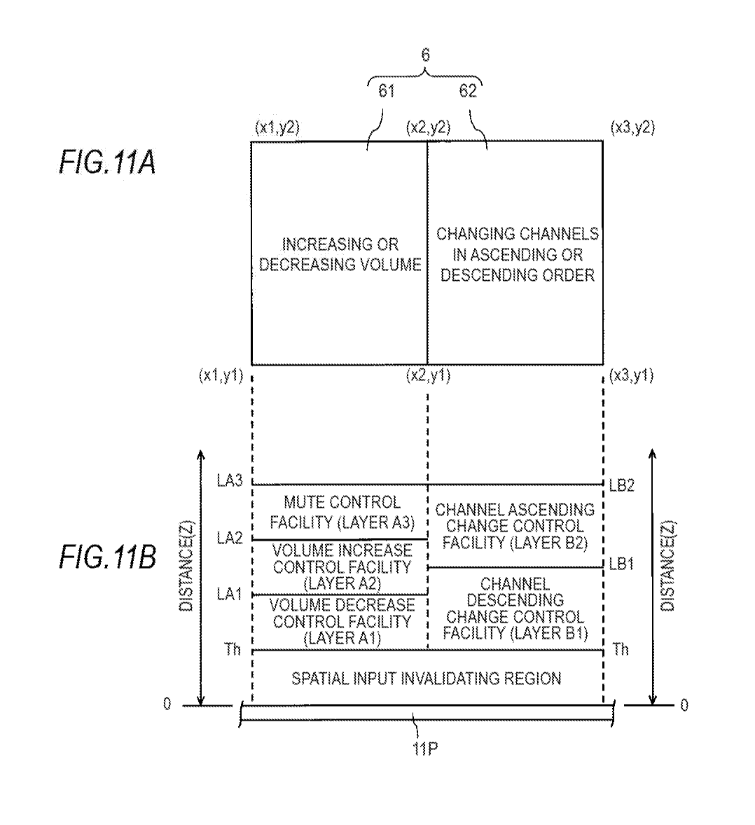

FIGS. 11A and 11B are diagrams showing the display area for the remote commander image 6 determined by the display image production block 211, multiple layers in the space above the display area, and an example of assignment of facilities.

The display image production block 211 defines, as shown in FIG. 11A, the rectangular display area for the remote commander image 6 in the display panel 4 according to the information on the position of seating of the user sent from the spatial position detection block 212.

As shown in FIG. 11A, the rectangular display area for the remote commander image 6 is defined with the x-coordinate and y-coordinate (x1,y1) indicating the left lower corner thereof and the x-coordinate and y-coordinate (x3,y2) indicating the right upper corner thereof. For example, the left-hand rectangular area within the area for the remote commander image 6 is designated as an area for the volume control display image 61, and the right-hand rectangular area within the area for the remote commander image 6 is designated as an area for the channel sequential change display image 62.

Specifically, the area for the volume control display image 61 is defined with the x-coordinate and y-coordinate (x1,y1) indicating the left lower corner thereof and the x-coordinate and y-coordinate (x2,y2) indicating the right upper corner thereof. The area for the channel sequential change display image 62 is defined with the x-coordinate and y-coordinate (x2,y1) indicating the left lower corner and the x-coordinate and y-coordinate (x3,y2) indicating the right upper corner thereof.

The display image production block 211 calculates the x1, x2 and x3 values and the y1 and y2 values on the basis of the information on the position of seating of a user sent from the spatial position detection block 212, and determines the display areas for the images.

The display image production block 211 stores information on determined settings of the remote commander image 6, and feeds the information on settings to the spatial motion input discrimination block 214 as described previously.

The display area for the remote commander image 6 is a rectangular area. Therefore, information on each area is information on a setting, that is, information including the x-coordinate and y-coordinate indicating the left lower corner and the x-coordinate and y-coordinate indicating the right upper corner. This is a mere example. Information to be used to specify each area is not limited to the information on a setting.

In the layer information storage block 213, information on layers in the space above the rectangular areas indicated with the x1, x2, and x3 values and the y1 and y2 values in FIG. 11A is stored. FIG. 11B shows an example of the information on layers.

In the present embodiment, a range defined with a predetermined distance from the surface of the table 3 is regarded as a spatial input invalidating region for fear the control unit 17 may recognize a user's hand, which is placed in contact with the surface of the table 3 but is not raised to the space above the table 3, as a remote-control motion.

Specifically, in the present embodiment, the control unit 17 decides whether the spatial distance of separation from the sensor panel surface of the front sensor unit 11, which is detected based on the sensor outputs of the front sensor unit 11, is equal to or longer than a predetermined distance Th. Only when the sensor outputs of the front sensor unit 11 signify that the distance is equal to or longer than the predetermined distance Th, the control unit 17 fetches the sensor outputs as information on a spatial motion input.

FIG. 11B shows an example of layers defined in the space above the remote commander image 6 and remote-control facilities assigned to the layers.

In the present embodiment, in the space above the sensor panel 11P of the front sensor unit 11, a region defined with the distance Th from the surface of the sensor panel 11P is regarded as an invalidation region. The control unit 17 ignores the sensor outputs, which are sent from the front sensor unit 11 in relation to the invalidating region, and recognizes the sensor outputs as those relating to an invalid spatial motion input.

Multiple layers are defined in a space, which is separated from the surface of the sensor panel 11P of the front sensor unit 11 by more than the distance Th, at different distances from the volume control display image 61 and channel sequential change display image 62 on the surface of the sensor panel 11P.

Specifically, three layers A1, A2, and A3 are defined in the space above the area for the volume control display image 61.

In this case, as shown in FIG. 11B, assuming that a display position on the sensor panel 11P is the position of an origin on the z axis, distances in the z-axis direction indicating the borders of the three layers A1, A2, and A3 are set to distances LA1, LA2, and LA3. Therefore, the ranges defined with the distances as the layers A1, A2, and A3 are expressed as Th<layer A1≦LA1, LA1<layer A2≦A2, and LA2<layer A3≦A3 respectively.

In the present embodiment, a volume decrease control facility is assigned to the layer A1, a volume increase control facility is assigned to the layer A2, and a mute control facility is assigned to the layer A3. The information on layers in the space above the volume control display image 61 is stored in the layer information storage block 213 in association with the information on the setting of the area including (x1,y1) and (x2,y2).

However, the information on the setting of the area including (x1,y1) and (x2,y2) and being stored in the layer information storage block 213 does not indicate the finalized area but signifies the rectangular area defined with the two point (x1,y1) and (x2,y2). Therefore, the x1, y1, x2, and y2 values are, as mentioned above, determined by the display image production block 211. The spatial motion input discrimination block 214 identifies the area for the volume control display image 61, which is stored in the layer information storage block 213, on the basis of the determined x1, y1, x2, and y2 values.

In the space above the area for the channel sequential change image 62, two layers B1 and B2 are defined at different distances from the surface of the sensor panel 11P. In this case, as shown in FIG. 11B, distances in the z-axis direction indicating the borders of the two layers B1 and B2 are set to distances LB1 and LB2. Namely, the ranges defined with distances as the layers B1 and B2 are expressed as Th<layer B1≦B1 and LB1<layer B2≦B2 respectively.

In the present embodiment, a channel descending change control facility is assigned to the layer B1, and a channel ascending change control facility is assigned to the layer B2. The information on the layers in the space above the channel sequential change display image 62 is stored in the layer information storage block 213 in association with the information on the setting of the area including (x2,y1) and (x3,y2).

The information on the setting of the area associated with the information on the layers in the space above the channel sequential change display image 62, which includes (x2,y1) and (x3,y2), does not, similarly to the information on the setting of the area for the volume control display image, indicate a finalized area. The x2, y1, x3, and y2 values are, as mentioned above, determined by the display image production block 211. The spatial motion input discrimination block 214 identifies the area for the channel change display image 62, which is stored in the layer information storage block 213, on the basis of the determined x2, y1, x3, and y2 values.

When multiple users are seated at the table 3, the remote commander image 6 is displayed at each of positions on the display panel 4 near the users. The information on the settings of the area for each of the remote commander areas 6 is sent from the display image production unit 211 to the spatial motion input discrimination block 214.

The spatial motion input discrimination block 214 receives all spatial input motions (hand gestures) made by the multiple users in the spaces above the multiple remote commander images 6 displayed for the users. In other words, any of the multiple users seated at the table 3 can remotely control the volume of the television set or change of the channels thereof by making a spatial input motion above the remote commander image 6 displayed near the user.

### (Processing Control Actions to be Performed by the Control Unit 17)

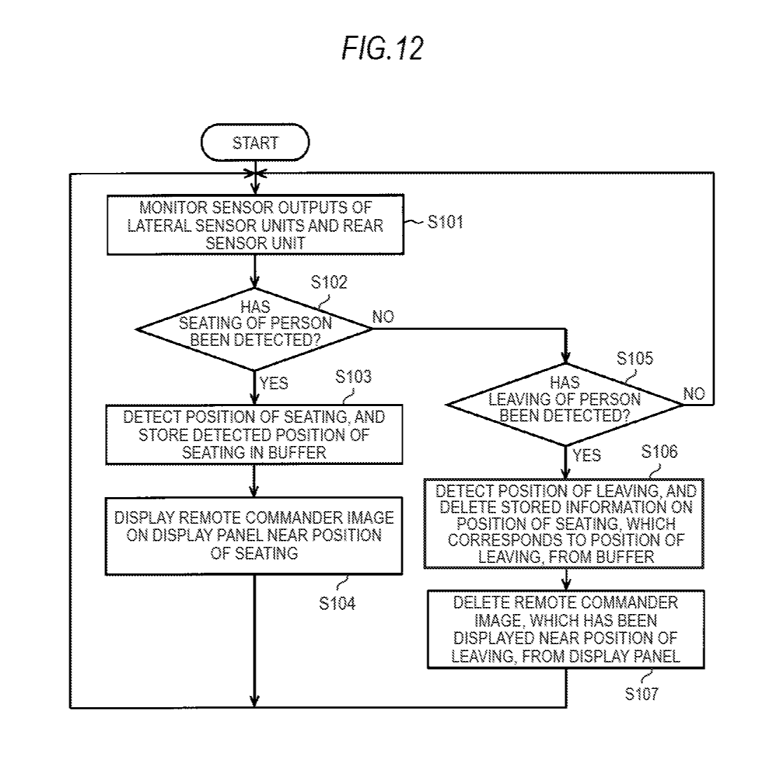

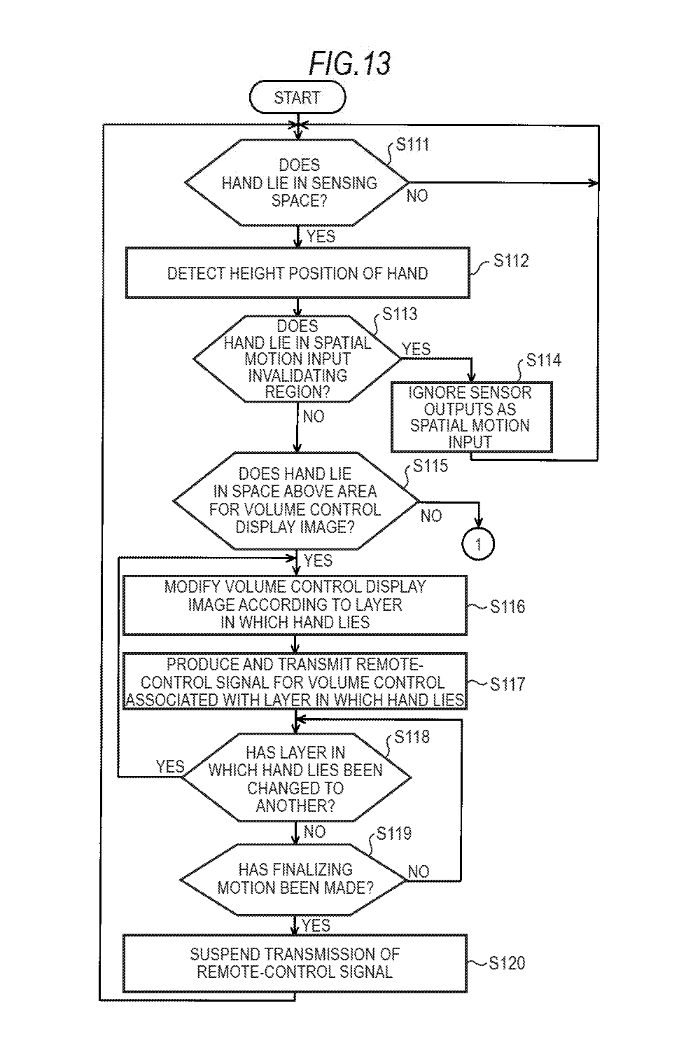

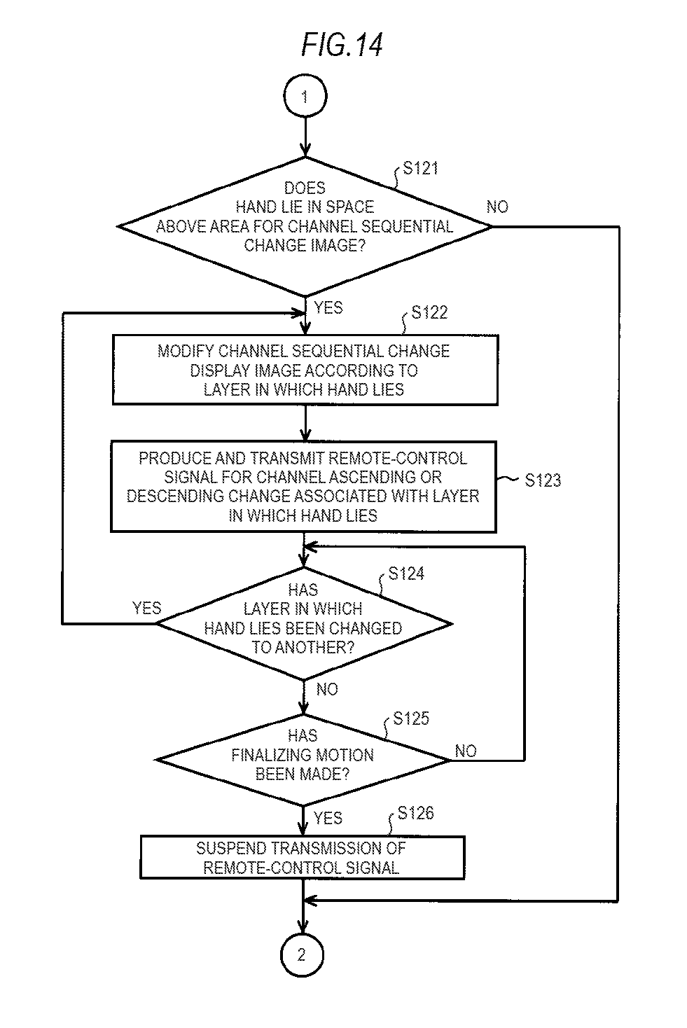

FIG. 12, FIG. 13, and FIG. 14 are flowcharts describing an example of processing actions to be performed in the control unit 17 included in the information processing system 1 of the present embodiment.

FIG. 12 is a flowchart describing processing actions to be performed in order to display or delete the remote commander image according to whether a user takes a seat at the table 3 or leaves the table 3. The CPU 201 executes the pieces of processing of steps described in the flowchart of FIG. 12 according to a program, which is stored in the ROM 202, using the RAM 203 as a work area. Specifically, the flowchart of FIG. 12 is concerned with a case where the capabilities of the display image production block 211, spatial position detection block 212, spatial motion input discrimination block 214, and remote-control signal production block 215 are implemented by pieces of software processing.

First, the CPU 201 in the control unit 17 monitors mainly the sensor outputs of the lateral sensor units 12 and 13 and rear sensor unit 14 (step S101), and decides whether the seating of a person (user) has been detected (step S102). Herein, the sensor outputs of the front sensor unit 11 are not used to detect the seating but may be, needless to say, used to detect the seating.

If the seating of a person has been detected at step S102, the CPU 201 instructs the spatial position detection block 212 to detect the position of seating at the table 3, store the positional information on the detected position of seating in a buffer, and then transfer the positional information to the display image production block 211 (step S103).

Under the control of the CPU 201, the display image production block 211 displays the remote commander image 6 on the display panel 4 at a position near the seated user (step S104). At this time, the display image production block 211 feeds the information on the display area for the remote commander image 6 to the spatial motion input discrimination block 214.

The CPU 201 returns to step S101 after completing step S104, and repeats pieces of processing of step S101 and subsequent steps.

If the CPU 201 decides at step S102 that the seating of a person has not been detected, the CPU 201 decides whether the leaving of the seated person has been detected (step S105). The leaving of a person is detected when the sensor outputs of the lateral sensor units 12 and 13 and the sensor outputs of the rear sensor unit 14 signify that the detected object has disappeared.

If the CPU 201 decides at step S105 that the leaving of a person has not been detected, the CPU 201 returns to step S101 and repeats pieces of processing of step S101 and subsequent steps.

If the CPU 201 decides at step S105 that the leaving of a person has been detected, the CPU 201 detects the position of leaving, deletes the information on the position of seating, which corresponds to the detected position of leaving, from the buffer, and provides the display image production block 211 with the information on the position of leaving (step S106).

Under the control of the CPU 201, the display image production block 211 deletes the remote commander image 6, which has been displayed near the user who has left the table, from the display panel 4, and notifies the spatial motion input discrimination block 214 of the fact (step S107).

The CPU 201 then returns to step S101, and repeats the pieces of processing of step S101 and subsequent steps.

FIG. 13 and FIG. 14 continuing FIG. 13 present an example of processing actions the control unit 17 performs to treat a spatial motion input that is entered with a user's hand gesture made in the space above the remote commander image 6. The CPU 201 executes the pieces of processing of steps described in the flowcharts of FIG. 13 and FIG. 14 according to programs, which are stored in the ROM 202, using the RAM 203 as a work area.

First, the CPU 201 decides whether the presence of a hand, which is an object, in a sensing space above the sensor panel of the front sensor unit 11 has been sensed (step S111). If the presence of the hand in the sensing space has not been sensed at step S111, the CPU 201 repeats step S111.

If the CPU 201 decides at step S111 that the presence of the hand in the sensing space has been sensed, the CPU 201 instructs the spatial position detection block 212 to detect the height position of the hand in the sensing space (the distance from the surface of the sensor panel 11P of the front sensor unit 11) (step S112).

Based on whether the detected height position of the hand, that is, the distance from the surface of the sensor panel 11P is larger than the distance Th, whether the height position of the hand lies in the spatial motion input invalidating region is decided (step S113).

If the CPU 201 decides that the hand is present in the spatial motion input invalidating region, the CPU 201 ignores the sensor outputs sent from the sensor unit 11 (step S114), and returns to step S111.

If the CPU 201 decides at step S113 that the hand does not lie in the spatial motion input invalidating region but lies in a space above the region, the CPU 201 decides whether the hand lies in the space above the area for the volume control display image 61 included in the remote commander image 6 (step S115).

If the CPU 201 decides at step S115 that the hand lies in the space above the area for the volume control display image 61, the CPU 201 identifies the layer in which the hand lies, and implements control to modify the volume control display image 61 into an image associated with the identified layer (step S116).

Thereafter, the CPU 201 produces a remote-control signal for volume control associated with the layer in which the hand lies, and transmits the remote-control signal via the remote-control transmission block 208 (step S117).

Thereafter, the CPU 201 decides based on the sensor outputs of the front sensor unit 11 whether the layer in which the hand lies has been changed to another (step S118). If the CPU 201 decides at step S118 that the layer in which the hand lies has been changed to another, the CPU 201 returns to step S116, and repeats the pieces of processing of step S116 and subsequent steps.

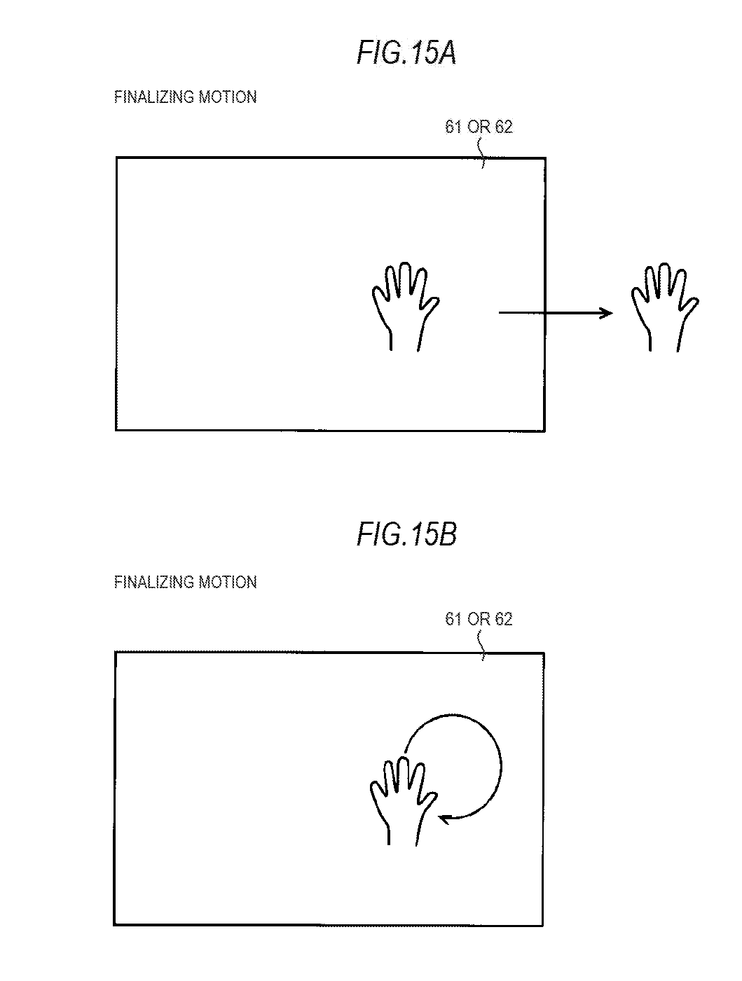

If the CPU 201 decides at step S118 that the layer in which the hand lies has not been changed to another, the CPU 201 decides whether a finalizing motion has been made (step S119). Now, the finalizing motion is, in this example, predetermined as a hand gesture within the layer. FIGS. 15A and 15B show examples of the finalizing motion.

In an example shown in FIG. 15A, a motion made by a hand, which lies in a layer, to move in a horizontal direction to outside the space above the volume control display image 61 or channel sequential change display image 62, which is included in the remote commander image 6 on the sensor panel 11P, without moving to another layer is regarded as a finalizing motion. The CPU 201 that is included in the control unit 17 and monitors the sensor output signals sent from the front sensor unit 11 recognizes the finalizing motion as the fact that the hand lying in a certain layer above the volume control display image 61 or channel sequential change display image 62 is not moved to any other layer but has disappeared.

In an example shown in FIG. 15B, a predetermined gesture or motion made by a hand in a layer without moving to any other layer, that is, a predetermined hand gesture is regarded as a finalizing motion. In the example shown in FIG. 15B, a hand gesture of drawing a circle is regarded as the finagling motion.

As mentioned above, in this example, the CPU 201 included in the control unit 17 can detect a movement, which an object makes in the x-axis or y-axis direction of the sensor panel 11P of the front sensor unit 11, on the basis of the sensor output signals sent from the front sensor unit 11. Therefore, the CPU 201 in the control unit 17 can detect a predetermined hand gesture made in a horizontal direction in a layer, and decide whether the gesture is a finalizing motion.

If the CPU 201 decides at step S119 that a finalizing motion has not been made, the CPU 201 returns to step S118. If the CPU 201 decides at step S119 that the finalizing motion has been made, the CPU 201 suspends transmission of a remote-control signal (step S120). Thereafter, the CPU 201 returns to step S111, and repeats the pieces of processing of step S111 and subsequent steps.

If the CPU 201 decides at step S115 that the hand does not lie in the space above the area for the volume control display image 61, the CPU 201 decides whether the hand lies in the space above the area for the channel sequential change display image 62 (step S121 in FIG. 14).

If the CPU decides at step S115 that the hand does not lie in the space above the area for the channel sequential change display image 62, the CPU 201 returns to step S111 and repeats the pieces of processing of step S111 and subsequent steps.

If the CPU decides at step S115 that the hand lies in the space above the area for the channel sequential change display image 62, the CPU 201 identifies the layer in which the hand lies, and implements control to modify the channel sequential change display image 62 into an image associated with the identified layer (step S122).

Thereafter, the CPU 201 produces a remote-control signal, which signifies channel sequential change associated with the layer in which the hand lies, and transmits the signal via the remote transmission block 208 (step S123).

Thereafter, the CPU 201 decides based on the sensor outputs of the front sensor unit 11 whether the layer in which the hand lies has been changed to another (step S124). If the CPU 201 decides at step S124 that the layer in which the hand lies has been changed to another, the CPU 201 returns to step S122 and repeats the pieces of processing of step S122 and subsequent steps.

If the CPU 201 decides at step S124 that the layer in which the hand lies has not been changed to another, the CPU 201 decides whether a finalizing motion has been made (step S125).

If the CPU 201 decides at step S125 that a finalizing motion has not been made, the CPU 201 returns to step S124. If the CPU 201 decides at step S125 that the finalizing motion has been made, the CPU 201 suspends transmission of a remote-control signal (step S126). Thereafter, the CPU 201 returns to step S111 and repeats the pieces of processing of step S111 and subsequent steps.

As mentioned above, in the information processing system of the first embodiment, the remote commander image is displayed in the vicinity of the position of seating of a user who is seated at the table 3. Predetermined remote control can be implemented responsively to a user's spatial motion input made in the space above the remote commander image. This will prove very useful.

In the above description of the first embodiment, not only the front sensor unit 11 but also the lateral sensor units 12 and 13 and the rear sensor unit 14 are structured to have two panels of the X-Z sensor panel and Y-Z sensor panel layered. However, since the lateral sensor unit 12 or 13 should merely be able to detect the position of a person in a horizontal direction (x-axis direction) of a side surface of the table 3, the lateral sensor units 12 and 13 may be formed with the X-Z sensor panel alone.

Likewise, when the rear sensor unit 14 is used in combination with the lateral sensor units 12 and 13 to detect seating of a person, the rear sensor unit 14 may be formed with the X-Z sensor panel alone.

In the above description of the embodiment, the display panel 4 is disposed on the side of the front surface of the table 3. Since only the remote commander image should be displayed on the display panel 4, the display panel may not be extended to the center part of the table 3.

### Second Embodiment

Even in an information processing system of a second embodiment, a table having nearly the same components as the table 3 in the first embodiment is employed. Therefore, even in the information processing system of the second embodiment, similarly to that of the first embodiment, the position of a person who is seated at the table 3 can be accurately identified using the sensor units 11 to 14.

However, the information processing system of the second embodiment is applied to usage different from the information processing system 1 of the first embodiment is, and does not act as a remote-control signal generation system.

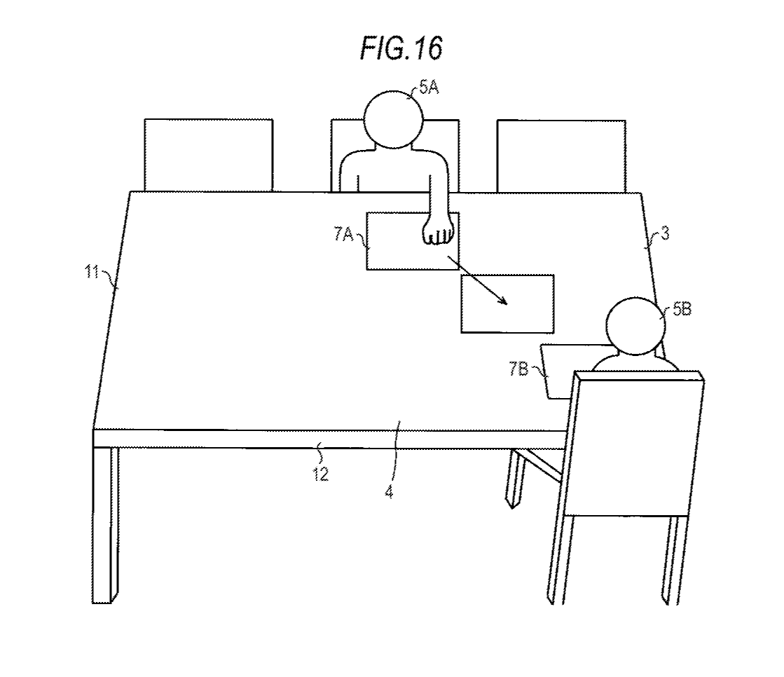

In the information processing system of the second embodiment, as shown in FIG. 16, document images 7A and 7B expressing conference papers are displayed on the display panel 4 of the table 3 in front of conferees 5A and 5B who are seated. If the document images for the conferees need not be discriminated from each other, the suffixes A and B will be deleted and the document images will generically be called the document image 7.

In the information processing system of the second embodiment, the conferee can move the document image 7, which expresses a conference paper and is displayed on the display panel 4, to the other debating party for the purpose of giving an explanation to the other debating party, or can rotate the document image 7.

In the information processing system of the second embodiment, a user's motion for moving or rotating the document image 7 is a user's gesture to be made in the space above the front sensor unit 11.

The control unit 17 included in the information processing system of the second embodiment receives, similarly to the one included in the first embodiment, the sensor outputs from the sensor units 11 to 14, and displays a predetermined display image on the display panel 4. However, the control unit 17 is different from the one included in the first embodiment in a point described below.

Specifically, the control unit 17 included in the information processing system of the second embodiment does not include the remote-control signal transmission block 208 and remote-control signal production block 215 shown in the block diagram of FIG. 7. In the image memory 210, information on the document image 7 that expresses a conference paper and is displayed on the display panel 4 is stored.

The display image production block 211 receives information on the position of seating of a conferee from the spatial position detection block 212, and determines a display area on the display panel 4, in which the document image 7 expressing a conference paper is displayed, at a position in front of the position of seating of the conferee. The display image production block 211 then displays the document image 7, which expresses a conference paper and is read from the image memory 210, in the determined display area.

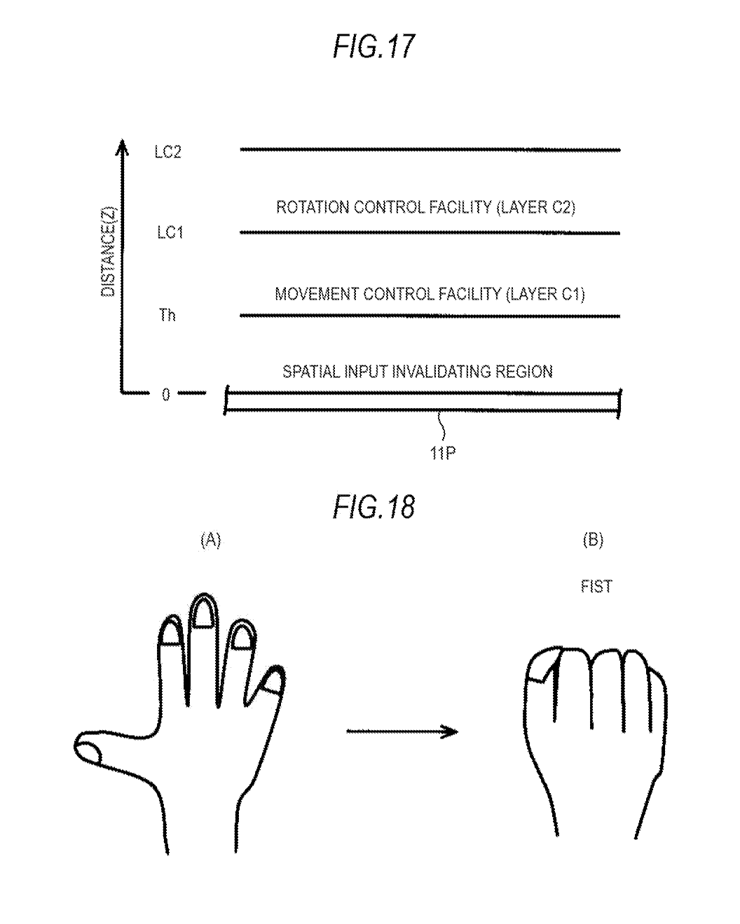

In the second embodiment, information on layers in the space above the document image 7 expressing a conference paper is stored in the layer information storage block 213. In the second embodiment, the information on layers has a structure like the one shown in FIG. 17.

FIG. 17 is a diagram showing an example of multiple layers in the space above the display area for the conference document image 7, and assignment of facilities to the layers.

Even in the second embodiment, in the space above the sensor panel 11P of the front sensor unit 11, a region defined with the distance Th from the surface of the sensor panel 11P shall be an invalidating region. The control unit 17 ignores the sensor outputs, which are sent from the front sensor unit 11 in relation to the region, and recognizes the sensor outputs as those relating to an invalid spatial motion input.

In the space above the display area for the document image 7 separated from the surface of the sensor panel 11P of the front sensor unit 11 by more than the distance Th, multiple layers are defined at different distances from the surface of the sensor panel 11P.

As shown in FIG. 17, in this example, two layers C1 and C2 are defined in the space above the display area for the document image 7.

In this case, as shown in FIG. 17, assuming that the position of the surface of the sensor panel 11P of the front sensor unit 11 is regarded as the position of an origin 0 on the z axis, distances in the z-axis direction indicating the borders of the two layers C1 and C2 are set to distances LC1 and LC2 respectively. The ranges defined with distances as the layers C1 and C2 are therefore expressed as Th<layer C1≦C1 and LC1<layer C2≦C2 respectively.

In the present embodiment, a control facility for movement (drag) of the document image 7 is assigned to the layer C1, and a control facility for rotation of the document image 7 is assigned to the layer C2. Information on the layers in the space above the document image 7 is stored in the layer information storage block 213.

The spatial motion input discrimination block 214 receives the three-dimensional position of a user's hand, which is an object, indicated by the sensor outputs of the front sensor unit 11 sent from the spatial position detection block 212, and decides whether the position lies in the region above the document image 7 that expresses a conference paper and that is displayed on the display panel 4. If the spatial motion input discrimination block 214 decides that the user's hand lies in the region above the document image 7 expressing a conference paper, the spatial motion input discrimination block 214 recognizes the hand gesture as a spatial motion input, and references the information on layers in the layer information storage block 213 so as to identify the assigned control facility. The control unit 17 performs a drag or a rotation, which is associated with the identified hand gesture, on the displayed document image 7.

In this case, if multiple users are seated at the table 3, the document image 7 is displayed at positions on the display panel 4 near the respective users. Pieces of information on the settings of the areas for the respective document images 7 are sent from the display image production block 211 to the spatial motion input discrimination block 214.

Therefore, the spatial motion input discrimination block 214 can receive all users' spatial input motions (hand gestures) made in the spaces above the respective document images 7 displayed for the multiple users.

Examples of user's hand gestures for moving and rotating the document image 7 will be described below.

To begin with, in the present embodiment, a gesture for designating (determining) the document image 7 to be moved or rotated among the document images 7 displayed on the display panel 4 is, as shown in part (B) of FIG. 18, a gesture of clenching a hand having been left open as shown in part (A) of FIG. 18. The gesture shall be called, in this specification, a clenching gesture.

The spatial motion input discrimination block 214 infers the clenching gesture from a change in the distribution of three-dimensional positions of a hand, which is an object, indicated by the sensor outputs of the front sensor unit 11. If the spatial motion input discrimination block 214 detects the clenching gesture in the space above any of the document images 7 displayed on the display panel 4, the spatial motion input discrimination block 214 decides that the document image 7 is determined as an object of drag or rotation.

If the layer in which the clenching gesture is detected is the layer C1, the spatial motion input discrimination block 214 references the layer information storage block 213 and decides that the drag control facility has been selected.

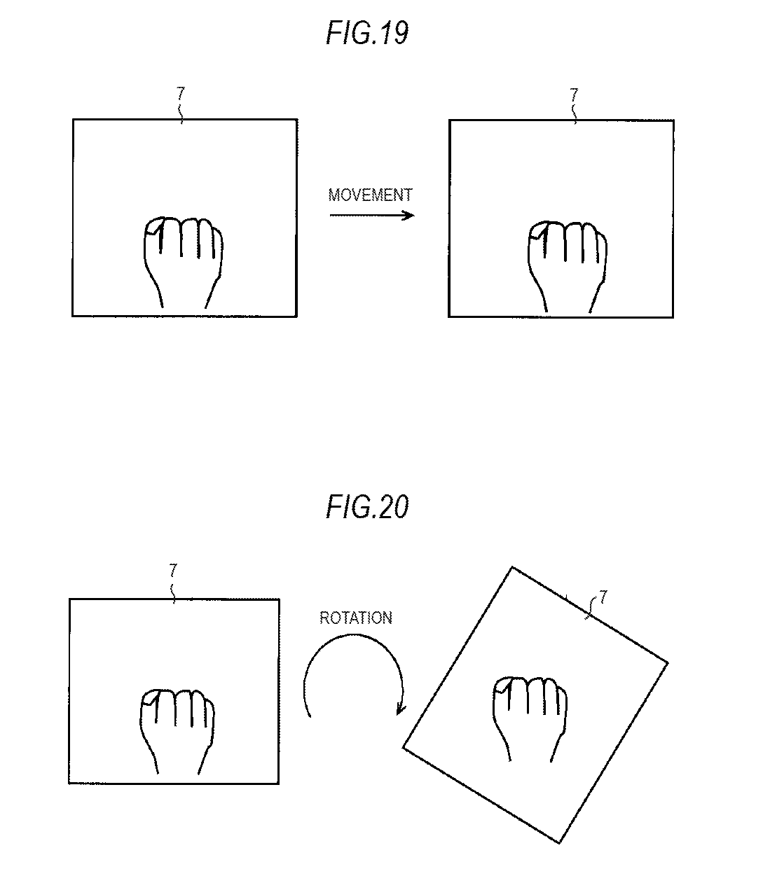

When a user moves, for example, as shown in FIG. 19, his/her first in a horizontal direction, the spatial motion input discrimination block 214 sends information on coordinates, which expresses the moving motion, to the display image production block 211. The display image production block 211 having received the information produces a display image, in which the document image 7 below the first is shown to have been dragged according to the moving motion of the user's fist, and displays the display image on the display panel via the display controller 209.

When the layer in which the clenching gesture is detected is the layer C2, the spatial motion input discrimination block 214 references the layer information storage block 213 and decides that the control facility for rotation of the document image 7 has been selected.

If a user makes, for example, as shown in FIG. 20, a motion of rotating his/her fist, the spatial motion input discrimination block 214 sends information on coordinates, which expresses the rotating motion, to the display image production block 211. The display image production block 211 having received the information produces a display image, in which the document image 7 below the first is shown to have been rotated according to the rotating motion of the user's fist, and displays the display image on the display panel 4 via the display controller 209.

### (Processing Control Actions to be Performed in the Control Unit 17 Included in the Second Embodiment)

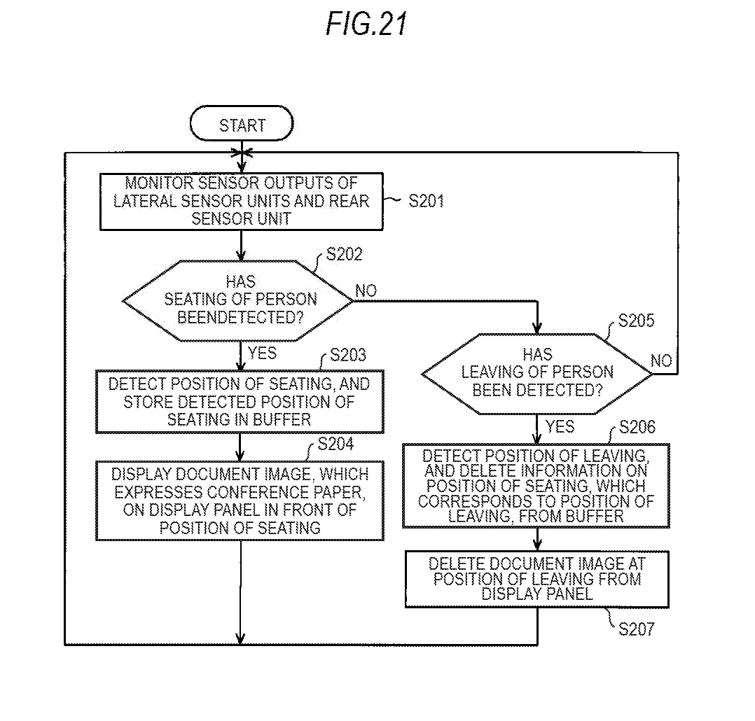

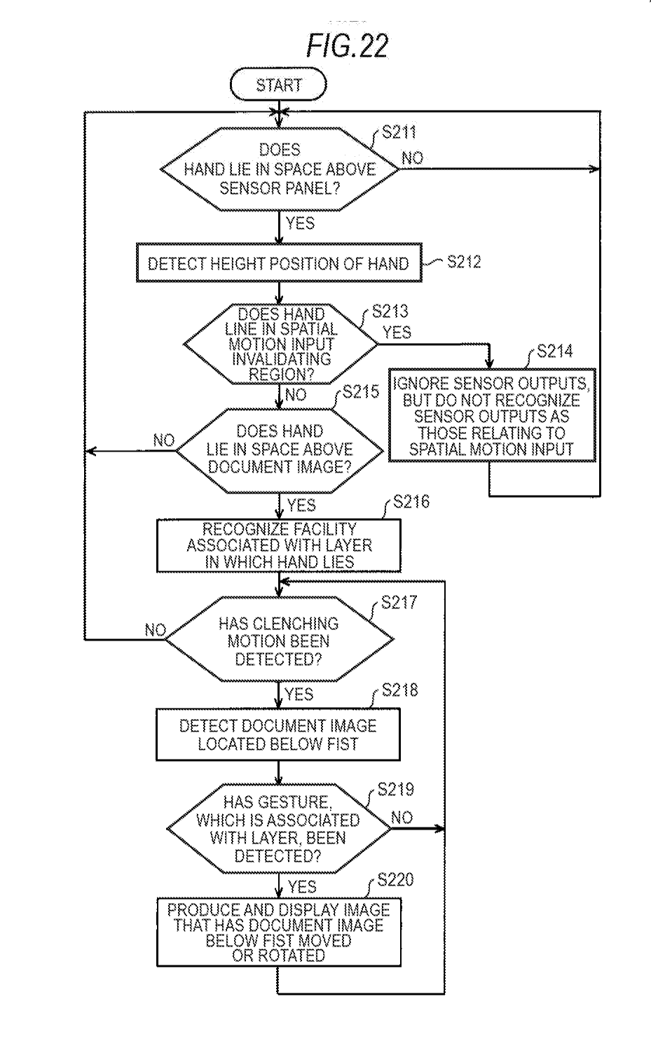

FIG. 21 and FIG. 22 are flowcharts describing examples of processing actions to be performed in the control unit 17 included in the information processing system of the second embodiment.

FIG. 21 is a flowchart describing processing actions to be performed in order to display or delete the document image 7, which expresses a conference paper, according to whether a user takes a seat at or leaves from the table 3. The CPU 201 executes the pieces of processing of steps described in the flowchart of FIG. 21 according to a program, which is stored in the ROM 202, using the RAM 203 as a work area. In other words, the flowchart of FIG. 21 is concerned with a case where the capabilities of the display image production block 211, spatial position detection block 212, and spatial motion input discrimination block 214 are implemented by pieces of software processing.

First, the CPU 201 included in the control unit 17 mainly monitors the sensor outputs of the lateral sensor units 12 and 13 and the sensor outputs of the rear sensor unit 14 (step S201), and decides whether the seating of a person (user) has been detected (step S202). Herein, the sensor outputs of the front sensor unit 11 are not used to detect the seating, but may be, needless to say, used to detect the seating.

If the seating of a person has been detected at step S202, the CPU 201 instructs the spatial position detection block 212 to detect the position of seating at the table 3, store positional information on the detected position of seating in a buffer, and transfer the positional information to the display image production block 211 (step S203).

Under the control of the CPU 201, the display image production block 211 displays the document image 7, which expresses a conference paper, on the display panel 4 at a position in front of the seated user (step S204). At this time, the display image production block 211 feeds information on the display area for the document image 7 to the spatial motion input discrimination block 214.

The CPU 201 returns to step S201 after completing step S204, and repeats the pieces of processing of step S201 and subsequent steps.

If the CPU 201 decides at step S202 that the seating of a person has not been detected, the CPU 201 decides whether leaving of the seated person has been detected (step S205). The leaving of the person is detected when the sensor outputs of the lateral sensor units 12 and 13 and those of the rear sensor unit 14 signify that the detected object has disappeared.

If the CPU 201 decides at step S205 that the leaving of a person has not been detected, the CPU 201 returns to step S201 and repeats the pieces of processing of steps S201 and subsequent steps.

If the CPU 201 decides at step S205 that the leaving of a person has been detected, the CPU 201 detects the position of leaving, deletes the information on the position of seating, which corresponds to the detected position of leaving, from the buffer memory, and provides the display image production block 211 with the information on the position of leaving (step S206).

Under the control of the CPU 201, the display image production block 211 deletes the document image 7, which is displayed near the user who has left, from the display panel 4, and notifies the spatial motion input discrimination block 214 of the fact (step S207).

The CPU 201 returns to step S201 and repeats the pieces of processing of step S201 and subsequent steps.

FIG. 22 describes an example of processing actions to be performed in the control unit 17 in order to treat a spatial motion input that is entered with a user's hand gesture made in the space above the document image 7. The CPU 201 executes the pieces of processing of steps, which are described in the flowchart of FIG. 22, according to a program stored in the ROM 202 using the RAM 203 as a work area.

First, the CPU 201 decides whether the presence of a hand, which is an object, is sensed in the sensing space above the sensor panel of the front sensor unit 11 (step S211). If the presence of the hand has not been sensed in the sensing space at step S211, the CPU 201 repeats step S211.

If the CPU 201 decides at step S211 that the presence of the hand is sensed in the sensing space, the CPU 201 instructs the spatial position detection block 212 to detect the height position of the hand in the sensing space (distance from the surface of the sensor panel 11P of the front sensor 11) (step S212).

Based on whether the detected height position of the hand, that is, the distance (z-coordinate) from the surface of the sensor panel 11P is larger than the distance Th, whether the height position of the hand lies in the spatial motion input invalidating region is decided (step S213).

If the CPU 201 decides that the hand lies in the spatial motion input invalidating region, the CPU 201 ignores the sensor outputs of the sensor unit 11 (step S214) and returns to step S211.

If the CPU 201 decides at step S213 that the hand does not lie in the spatial motion input invalidating region but lies in the space above the region, the CPU 201 decides whether the hand lies in the space above the area for the document image 7 (step S215).

If the CPU 201 decides at step S115 that the hand does not lie in the space above the area for the volume control display image 61, the CPU 201 returns to step S211.

If the CPU 201 decides at step S115 that the hand lies in the space above the area for the volume control display image 61, the CPU 201 identifies the layer, in which the hand lies, on the basis of information on a z-coordinate obtained from the sensor outputs of the front sensor unit 11. The CPU 201 then recognizes the control facility assigned to the identified layer (step S216).

Thereafter, the CPU 201 instructs the spatial motion input discrimination block 214 to decide on the basis of the pieces of information on an x-coordinate and a y-coordinate, which are contained in the sensor outputs of the front sensor unit 11, whether the user's hand has made a clenching gesture (step S217). If a decision is made at step S217 that the user's hand has not made the clenching gesture, the CPU 201 returns to step S211 and repeats the pieces of processing of step S211 and subsequent steps.

If a decision is made at step S217 that the user's hand has made the clenching gesture, the CPU 201 detects the document image, above which a clenching motion has been made, on the basis of the pieces of information on the x-coordinate and y-coordinate contained in the sensor outputs of the front sensor unit 11 (step S218).

Thereafter, the CPU 201 instructs the spatial motion input discrimination block 214 to decide whether a gesture associated with the layer in which the hand lies, that is, a horizontal movement (drag) associated with the layer C1 or a rotating motion associated with the layer C2 has been made (step S219).

If a decision is made at step S219 that the gesture associated with the layer in which the hand lies has not been made, the CPU 201 returns to step S217 and repeats the pieces of processing of step S217 and subsequent steps.

If a decision is made at step S219 that the gesture associated with the layer in which the hand lies has been made, the CPU 201 controls the display of the document image 7, above which the hand is clenched, so that the document image 7 will be dragged or rotated responsively to the user's hand gesture (step S220). The CPU 201 returns to step S216 after completing step S220, and repeats the pieces of processing of step S216 and subsequent steps.

As mentioned above, in the information processing system of the second embodiment, the document image is displayed on the display panel near the position of seating of a user (conferee) who is seated at the table 3. Based on the user's spatial motion input made in the space above the document image, the document image can be controlled, that is, dragged or rotated. This will prove very useful.

According to the patent document 1, when display is controlled, that is, a displayed document is moved or rotated, it is achieved responsively to a user's action performed using a PDA having a three-dimensional position sensor incorporated. Therefore, the user has to hold the PDA with the three-dimensional sensor and perform a predetermined action. In contrast, the second embodiment is advantageous in that the user need not hold the PDA or the like, but a display image can be controlled based on a spatial motion input entered with a hand gesture the user makes in the information space for the display image.

### Third Embodiment

The third embodiment is a variant of the second embodiment. In the second embodiment, similarly to the first embodiment, the table 3 is employed, and a flat display panel incorporated in the tabletop of the table 3 is adopted as a display unit.

In contrast, in the third embodiment, a flat display panel is not incorporated in the tabletop of the table 3, but a display image is projected or displayed on the surface of the tabletop of the table 3 from an image projection apparatus (projector).

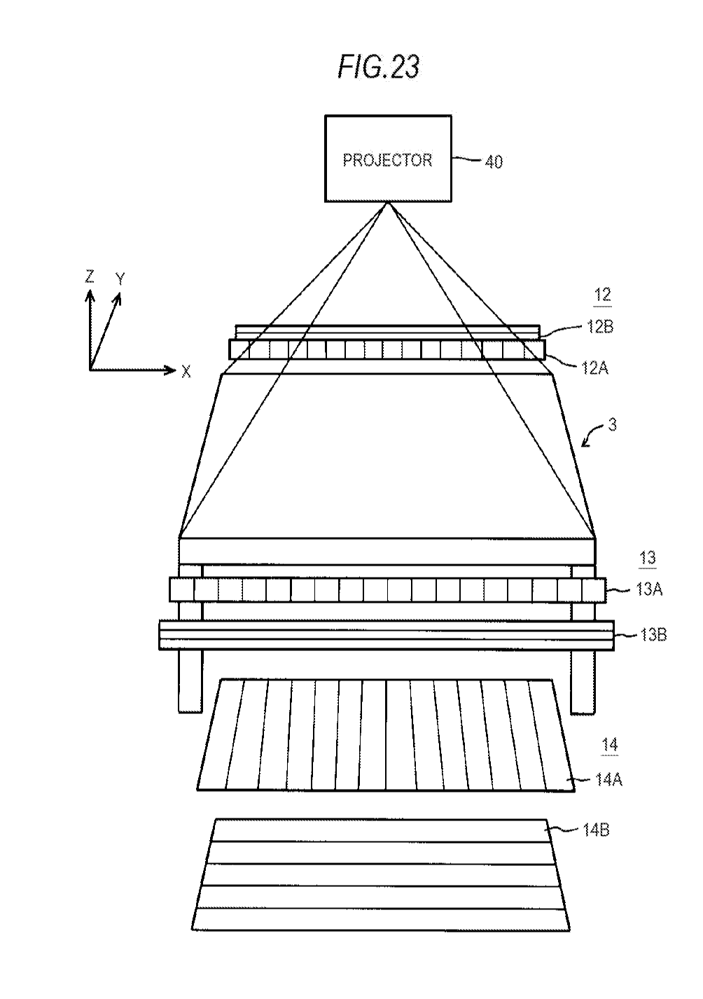

FIG. 23 is a diagram showing an example of the components of the third embodiment. Specifically, in the third embodiment, a display unit is realized with a projector 40 independent of an information processing apparatus. Therefore, the third embodiment is an information processing system including an information processing apparatus 8 that includes sensor units and a control unit, and the projector 40.

A sensor panel employed in the present embodiment in order to detect the three-dimensional position of an object using electrostatic capacitances covers as object detection regions not only a space above the sensor panel but also a space below it. However, in the first and second embodiments, since the display panel 4 is incorporated in the tabletop of the table 3, the front sensor unit 11 does not identify an object that lies in the space below it. The rear sensor unit 14 does not identify an object that lies in the space above it.

In contrast, in the third embodiment, since the display panel 4 is not incorporated in the tabletop of the table 3, one of the front sensor unit and rear sensor unit is adopted as a sensor panel that covers both the space above the tabletop of the table and the space below it.

In the example shown in FIG. 23, the rear sensor unit 14 alone is attached to the table 3 but the front sensor unit 11 is excluded. In the third embodiment, the rear sensor unit 14 provides sensor outputs that depend on a hand gesture made in the space above the remote commander image 6 or document image 7 projected or display on the surface of the tabletop of the table 3.

Therefore, allocation of layers to positions at distances from a threshold is achieved in consideration of the thickness of the tabletop of the table 3.

In the third embodiment, the image processing apparatus 8 and projector 40 are connected to each other through radiocommunication in consideration of the nuisance in laying down a connection cable.

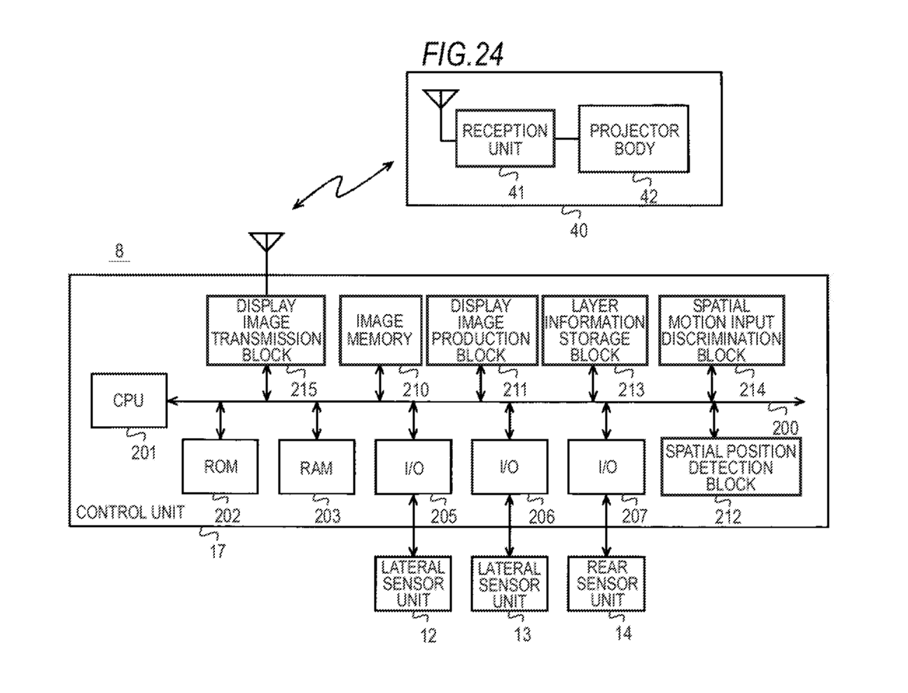

FIG. 24 is a block diagram showing an example of the configuration of the third embodiment similar to the configuration of the second embodiment.

Specifically, in the third embodiment, the projector 40 includes a radio reception unit 41 and a projector body 42 that uses information on a display image, which is acquired via the radio reception unit 41, to project an image.

In the present embodiment, the control unit 17 included in the information processing apparatus 8 includes blocks shown in FIG. 24. Specifically, the input/output port 204, remote-control signal transmission block 208, remote-control signal production block 215, and display controller 209 shown in the block diagram of FIG. 7 showing the control unit 17 are not included. Instead, the control unit 17 included in the third embodiment includes a display image transmission block 215 that transmits information on a display image produced by the display image production block 211 into the projector 40.

The display image production block 211 produces, in place of image information to be displayed on the display panel 4, image information to be projected or displayed on the surface of the table 3 by the projector 40. The contents of a display image represented by the produced image information are identical to those in the second embodiment.

In the third embodiment, the spatial position detection block 212 detects the three-dimensional position of a user's hand, which is an object, in the space above the surface of the table 3 using sensor outputs sent from the rear sensor unit 14. Therefore, the spatial motion input discrimination block 214 identifies a user's hand gesture on the basis of the three-dimensional position of the user's hand which the spatial position detection block 212 has detected using the sensor outputs of the rear sensor unit 14.

The other blocks are identical to those in the second embodiment.

Even in the third embodiment, needless to say, the front sensor unit 11 may be included for the purpose of detecting a user's hand gesture in more detail.

### (Other Embodiments and Variants)

In the first and second embodiments, a display panel realized with a flat display panel is incorporated in the entire surface of a table. Alternatively, a compact display panel may be incorporated in each of areas on the table at positions at which persons are supposed to be seated.

In this case, when a person is seated, only the compact display panel at the position of seating is powered, and processing actions identical to the aforesaid ones are carried out. Therefore, when the number of seated persons is limited, there is the merit that compared with a case where the display panel is incorporated in the entire front surface of the tabletop of a table, power consumption can be reduced.

In the aforesaid embodiments, the surface of the table is used to define a display area for an image. The present invention is not limited to this mode.

For example, a display panel may be incorporated in a front door and the sensor units may be incorporated therein. When approach of a person is detected, predetermined display may be achieved on the display panel, and an image to be displayed on the display panel may be changed to another according to a hand gesture the person makes in the space above the display image.

The present application contains subject matter related to that disclosed in Japanese Priority Patent Application JP 2008-299408 filed in the Japan Patent Office on Nov. 25, 2008, the entire contents of which is hereby incorporated by reference.

It should be understood by those skilled in the art that various modifications, combinations, sub-combinations and alterations may occur depending on design requirements and other factors insofar as they are within the scope of the appended claims or the equivalents thereof.

1. (canceled)

2. An information processing system comprising:
a display;
a sensor; and
circuitry configured to
detect a spatial position information of an object based on an input from the sensor,
ignore a first spatial position information when the first spatial position information is recognized as an invalid input based on a predetermined region,
identify a selected image based on position information of a displayed image when a second spatial position information is recognized as a valid input based on the predetermined region and the valid input is recognized as a gesture, and
perform an operation which is related to the gesture for the selected image.

3. The information processing system according to claim 2, wherein the predetermined region includes distance information between the object and the information processing apparatus.

4. The information processing system according to claim 2, wherein the predetermined region includes z-coordinate information.

5. The information processing system according to claim 2, wherein the displayed image of the selected image is controlled based on the operation.

6. The information processing system according to claim 2, wherein the position information of the displayed image includes x-coordinate information and y-coordinate information.

7. The information processing system according to claim 2, wherein a first displayed image corresponds to a first x-coordinate and a first y-coordinate and a second display image corresponds to a second x-coordinate and a second y-coordinate.

8. The information processing system according to claim 2, wherein the gesture input includes a hand gesture.

9. The information processing system according to claim 2, wherein the gesture input includes a gesture of clenching a hand having been left open.

10. The information processing system according to claim 2, wherein the operation includes a drag operation of the selected image.

11. The information processing system according to claim 2, wherein the operation includes a rotation operation of the selected image.

12. The information processing system according to claim 2, wherein the circuitry is configured to ignore the first spatial position information so as not to recognize the first spatial position information as spatial motion input.
